(19) United States
(12) Patent Application Publication
(10) Pub. No.: US 2001/0029455 A1
(43) Pub. Date: Oct. 11, 2001

(54) Method and apparatus for providing multilingual translation over a network

(76) Inventors: Jeffrey J. Chin, Sugar Land, TX (US); Christopher Callison-Burch, San Francisco, CA (US); Raymond S. Flournoy, San Francisco, CA (US); Pria Hidisyan, San Francisco, CA (US); Rina Horiuchi, Palo Alto, CA (US); Yannick Kassum, San Francisco, CA (US); Kevin Akira Lee, Cerritos, CA (US); Nicholas Lee, Morris Plains, NJ (US); David Lowsky, San Francisco, CA (US); Thomas Ritter, Berkeley, CA (US); David Weinstein, Palo Alto, CA (US)

Correspondence Address: WILSON SONSINI GOODRICH & ROSATI, 650 PAGE MILL ROAD, PALO ALTO, CA, 943041050

(21) Appl. No.: 09/825,437

(22) Filed: Apr. 2, 2001

Related U.S. Application Data
(60) Provisional application No. 60/193,937, filed on Mar. 31, 2000.
(60) Provisional application No. 60/212,553, filed on Jun. 20, 2000.

(51) Int. Cl. G10L 21/00

(52) U.S. Cl. 704/277

(57) ABSTRACT

A method for electronically translating text provides an electronic language translator. Source language text is received as an input to the electronic language translator. The source language text is translated at the electronic language translator at the time of submission into one or more target language texts. A user is then provided with an option of viewing one or more of the target language texts with or without the source language texts.

### CROSS-REFERENCE TO RELATED APPLICATIONS

This application is a continuation-in-part of, and claims the benefit of, U.S. provisional application Ser. No. 60/193,937, filed Mar. 31, 2000, and Ser. No. 60/212,553, filed Jun. 20, 2000, which applications are fully incorporated by reference

### BACKGROUND OF THE INVENTION

1. Field of the Invention

This invention relates generally to translation methods and apparatus, and more particularly to translation methods and apparatus over a network.

2. Description of the Related Art

In most computer systems involving a central host processor and numerous distributed access devices such as video display terminals, information is transferred between the host and each access device via a screen display formed as an integral part of the access device. The screen serves the two-fold purpose of displaying input information provided by a user as well as displaying user-readable output information, generated by host processing, to the user. The input information is generally provided by the user via entries on a keyboard also formed as an integral part of each access device. Input or output information is typically composed of an arrangement of system-provided words or phrases followed by user or system-supplied data fields displayed in a predetermined pattern on the screen.

In conventional systems, an application executing on the host utilizes only a limited number of screen patterns or formats so that only a standard set of screen images corresponding to the formats may be called into view by the user for input or invoked by the host processing for output. The definition of each screen format is typically deeply embedded in the source code for the application. There is essentially no flexibility provided to the user to allow for the creation of customized formats and, correspondingly, their screen images. In order to expand the user base of a previously developed software application system, particularly to allow foreign affiliates of the system developer full utilization of system capabilities, major modifications to the source code of the system have conventionally been required, such as by rewriting significant portions of the code implementing input/output (I/O) interface functions.

The foremost modification in the above special situation is that of translating the descriptive words or phrases from the original language (e.g., English) to a different language (e.g., Spanish). If there are affiliates from numerous foreign countries then, besides the effort of rewriting the source code, multiple copies of modified source code require storing, tracking and updating. Such a task becomes unwieldy, burdensome and costly. Thus, for example, if a source code module uses or produces user-viewable information, then there must be a different copy of the module for each language executable by that software. Besides the actual system copies of the code, support software is required to inform the system developer of the status of the multiple copies. Moreover, additional storage devices are needed to store all the additional versions of the software. For a large scale system involving millions of lines of code and thousands of modules, the storage requirements may become enormous.

In addition to the problem of direct language translation, there are also problems as how to treat the data supplied to the data fields. It is usually required that certain data be converted, such as by converting from non-metric to metric, and other data be reordered, such as month/day/year versus day/month/year which is the convention of some foreign affiliates.

A translation environment which serves to buffer the host system to each of the access devices is disclosed in U.S. Pat. No. 4,870,610. Broadly speaking, the translation environment includes an autonomous processor interposed between the host system and each access device. Information transmitted in either direction between the host and access device is diverted to the processor for intermediate processing. The diverted information contains detailed character data either appearing on the input request screen originated at the access device or on the output response screen destined for the access device, depending upon the direction of original information transmission. The character data is of two types, namely, system-supplied field identifiers and user-provided data entries associated with the identifiers. Identifiers are expressed in a first user language (e.g., English).

In order to offer access to the host system by a user of a second language (e.g., Spanish), the screen displays and, most particularly, the identifiers are first translated to the second language via a format create process. The output of this create process is a translation file which stores the mapping relationship between the first language screen and its second language counterpart. The translation file is invoked by a translation execution process whenever the second language user accesses the host system. The contents of this file are used to translate from the second-to-first language upon a host request and from the first-to-second language upon a host response. A feature of this arrangement is that both the format create process and the translation execution process operate in the translation environment which is transparent to the host system. With the translation environment, the user may customize screen displays to maximize system utilization.

U.S. Pat. No. 5,966,685 is directed to a system of parallel discussion groups operated in conjunction with a message collection/posting software program, data filter software program, and a machine translation software program. A structure and process is created to enable discussion group users, of different languages, to communicate with one another. An automatic batch process is utilized that executes at a remote site. No human intervention is required for the pre-processing, translation, or post-processing functions. Additionally, users simply specify a language preference to realize the benefits and advantages of the present invention.

A number of discussion groups run in “parallel”; one group for each language being used in the discussion groups. The individual discussion groups all contain the same information, in the same order; the only difference being that each parallel discussion group is written in a different language. Once a user logs onto a particular parallel discussion group he or she may then choose his or her language preference. If the user's language preference is set to French, the French version of the discussion group will be accessed. Messages posted to a discussion group will be periodically collected, translated to the other languages, and then posted to those respective target language discussion groups. The collection and posting of the messages will be accomplished by the Message Collection/Posting Software The new messages which are collected on a periodic basis are sent to a commercially available Machine Translation (MT) software for translation. Messages are batch processed automatically at the network site and without human intervention. The translation takes place at a remote site so user actions are minimized.

Before the input text is actually submitted to the MT software, the input text is passed through a filter software program which preprocesses the data before it is submitted to the MT software. The filter identifies and marks strings which are best left untranslated by the MT software, such as personal names, company product names, file and path names, commands, samples of source code, and the like. By marking these strings, the filter notifies the MT software to leave those strings untranslated. These strings are then linked to a preceding “hookword”. Hookwords are automatically inserted then deleted in post-processing and are contained in dictionaries with a part-of-speech and other grammatical features to effect rearrangement of the word in the target language. Once the translation process is complete, the translations are collected and posted, by the Message Collection/Posting Software, to the target language discussion groups at the same location within the message structure as the original version of the message. The pre-processing, translation, and post-processing functions are all performed automatically in accordance with a batch process that executes on a periodic basis at the network site.

U.S. Pat. No. 5,960,382 discloses a method and apparatus for translating a native-language message into a corresponding foreign-language message. Translation of an initially-unknown message is effected using native-language and foreign-language prototype messages that are independent of message variables, whereby a prototype message represents all messages of an individual type. An individual message is identified to belong to a particular type by using the native-language prototype message, and an equivalent foreign-language message is then generated by inserting variable values from the individual message into the foreign-language prototype message that represents the particular message type.

The native-language message, which includes a value of a variable, is matched against a plurality of native-language prototype messages to identify a corresponding native-language prototype message, which includes the variable. The plurality of native-language prototype messages preferably represent all native-language messages that require translation. The identification of the prototype native-language message is used to obtain (e.g., retrieve) a corresponding foreign-language prototype message, which also includes the variable.

The value of the variable, obtained from the native-language message that is being translated, is then substituted for the variable in the obtained foreign-language prototype message to yield a foreign-language message which corresponds to (i.e., which is a translation of) the native-language message. If the native language message includes values of a plurality of variables, the identified native-language prototype message and the corresponding foreign-language prototype message each includes the plurality of variables. The plurality of the variables have a first ordering in the identified native-language prototype message and a second ordering in the corresponding foreign-language prototype message, and the two orderings are generally different.

The substitution step then involves using the first ordering and the second ordering to determine a placement of the values of the variables into the obtained foreign-language prototype message. Preferably, the matching step involves the use of a multi-tiered multi-node tree constructed from the native-language prototype messages, and matching strings (e.g., words and numerals) which make up the native-language message in their order against the nodes of corresponding tiers in the tree to reach a node which represents the last string in the message and contains the message identifier of the corresponding prototype message. This identifier is then used to obtain the corresponding foreign-language prototype message, which has the same identifier.

There is a need for a language translation method and apparatus for networks that addresses issues associated with two-bit characters. There is a further need a language translation method and apparatus for networks that provides for user feedback. There is a further need for a language translation method and apparatus for networks that limits subject matter and language usage domains. Yet there is another need for a language translation method and apparatus for networks that takes advantage of application-specific characteristic repetitions in language.

### SUMMARY OF THE INVENTION

Accordingly, an object of the present invention is to methods and apparatus that improve the quality and usability of the translations.

Another object of the present invention is to provide language translation methods and apparatus suitable for the internet and other distributed networks.

Yet another object of the present invention is to provide language translation methods and apparatus that provide user feedback.

A further object of the present invention is to provide language translation methods and apparatus for the internet that limits subject matter and language usage domains.

Another object of the present invention is to provide language translation methods and apparatus for networks that takes advantage of application-specific characteristic repetitions in language.

Another object of the present invention is to provide language translation methods and apparatus for the internet that provide user feedback relative for determining whether inputs are translated correctly.

Another object of the present invention is to provide language translation methods and apparatus that actively educate users on how to use translation engines.

Another object of the present invention is to provide language translation methods and apparatus with user defined dictionaries.

Another object of the present invention is to provide language translation methods and apparatus that provide user direction and customization of translation.

Another object of the present invention is to provide language translation methods and apparatus that permit modification in order to better handle the characteristic language of different specific applications.

Another object of the present invention is to provide language translation methods and apparatus that provide a static translation cache of frequently encountered phrases,

Another object of the present invention is to provide language translation methods and apparatus that provide a key form for storing cached phrases which removes extraneous information.

Another object of the present invention is to provide language translation methods and apparatus that provides for the most flexible and productive application of a phrase cache.

Another object of the present invention is to provide language translation methods and apparatus that provide typing shortcuts for languages and allow free deletion of selected clauses.

Another object of the present invention is to provide language translation methods and apparatus that provide simultaneous display of original and translated content or messages from a network on a single screen without disrupting the look and feel.

Another object of the present invention is to provide language translation methods and apparatus that provides for personalization.

Another object of the present invention is to provide language translation methods and apparatus that is real-time and does not cause delay for the user.

Another object of the present invention is to provide language translation methods and apparatus that inclues multiple translation engines in a single system with a uniform API.

Another object of the present invention is to provide language translation methods and apparatus that provides a uniform API to numerous applications.

These and other objects of the present invention are achieved in a method for electronically translating text. An electronic language translator is provided. Source language text is received as an input to the electronic language translator. The source language text is translated at the electronic language translator at the time of submission into one or more target language texts. A user is then provided with an option of viewing one or more of the target language texts with or without the source language texts.

In another embodiment of the present invention, a method for electronically translating text provides an electronic language translator system that includes an electronic language translator and at least a first and a second dictionary. The electronic language translator references the first dictionary and then the second dictionary in a process of translating source language text into one or more target language texts. The dictionaries are maintained in an application or customer hierarchy. Source language text is received at an input of the electronic language translator. The source language text is translated at the electronic language translator into one or more target language texts. An output is produced that includes the one or more target language texts.

In another embodiment of the present invention, a method for electronic language translation provides one or more translation modules receiving source language text from an input interface. One or more input interfaces and one or more output interfaces are provided. A generic data format is included that is independent of the translation modules, input interfaces, and output interfaces. The input source language text is converted from the format for a specific input interface to the generic format. A determination is made of the one or more translation modules that provides an optimal translation. The text is routed to the module that provides the optimal translation. Text is converted from the generic data format to a specific input format of a translation module. The specific output format from a translation module is converted to the generic data format. Data is converted from the generic data format into an output format suitable for an output interface.

In another embodiment of the present invention, a method for electronically translating text provides an electronic language translator coupled to an interface. Source language text is translated at the electronic language translator into one or more target language texts. Translated text is output in one or more target languages to an output interface. Controls are provided at an interface coupled to the electronic language translator to dynamically select which of the one or more target languages are output at the interface. The interface representation of text is varied in the one or more target languages to allow a user to differentiate between the displayed languages. Controls are provided at an interface to create differentiation between one or more target languages.

In another embodiment of the present invention, a method for electronically translating text provides an electronic language translator coupled to an interface. The source language text is translated at the electronic language translator into one or more target language texts. The translated output is displayed to the original user. Feedback is provided to the original user about the quality of the translation.

In another embodiment of the present invention, a method for electronically translating text provides an electronic language translator coupled to an interface. The source language text is translated at the electronic language translator into one or more target language texts. At least two candidate translations are produced for each source language text. The translated candidates are compared to one or more language models trained on data similar in style and subject matter to the text being translated. The best quality translation is selected for the input from the multiple translation candidates according to which best matches the one or more language models. A desired best quality translation is then displayed.

In another embodiment of the present invention, a system for electronically translating text includes an electronic language translator that receives source language text input and produces translated target language text. An interface is coupled to the electronic language translator and configured to provide a user with an option of viewing one or more target language texts with or without source language text.

### BRIEF DESCRIPTION OF THE FIGURES

FIG. 1 describes a screenshot of a chat application of the present invention.

FIGS. 2-3 describe embodiments of the real-time multilingual communication application of the present invention.

FIG. 4 is a high level overview illustrating operation of the System of the present invention.

FIG. 5 is a high level overview illustrating operation of the System of the present invention.

FIG. 6 is a high level overview illustrating operation of the System of the present invention.

FIG. 7 illustrates data flow between the client wireless device, the wireless network provider, the data provider, and the translation services of the present invention.

FIG. 8 illustrates a generic peer-to-peer data exchange.

FIG. 9 illustrates a generic client-server data exchange, where the translation service of the present invention acts as the intermediary in the data exchange

FIGS. 10(a)-10(b) are directed to an auction tool embodiment of the present invention which combines features of the multi-lingual search engine and the browsing tool of the present invention

FIG. 11 shows the dynamic translation cache of the present invention.

FIG. 12 illustrates the framework of the present invention.

FIG. 13 illustrates the five steps performed at the translation

FIG. 14 illustrates the procedures that each step of transation undergoes of the present invention.

FIG. 15(a) illustrates the full linguistic processing occurring in the chat application of the present invention.

FIG. 15(b) is similar to FIG. 15(a) with the same data path, for non-interactive applications of the present invention.

FIG. 16 illustrates input aids incorporated into the System of the present invention.

FIG. 17 illustrates a common phrase table with the static translation cache of the present invention.

FIG. 18 illustrates language post-processing of the present invention.

FIG. 19 illustrates text post-processing of the present invention.

FIG. 20 illustrates text pre-processing of the present invention.

FIG. 21 is a continuation of FIG. 8 illustrating language preprocessing of the present invention.

FIG. 22 illustrates the translation engines with dictionaries of different types of the present invention.

FIG. 23 shows a topic specific dictionary of the present invention.

FIG. 24 illustrates the four types of feedback produced and utilized by the System of the present invention.

FIG. 25 shows the levels of feedback which are incorporated in the translation system of the present invention.

FIG. 26 illustrates the way the System of the present invention educates the user about the MT engine, as well as about his or her own language.

FIG. 27 describes the browsing tool of the present invention on a high level as a three-step process:

FIG. 28 is a high-level blowup of step 2 from FIG. 27.

FIG. 29 provides more detail of step 2 from FIG. 27 for page retrieval and processing.

FIG. 30 is a blowup of page retrieval as represented in FIG. 29.

FIG. 31 is a blowup of step 1 from FIG. 30 describing how parameters are added to a URL before querying the source site.

FIG. 32 is a blowup of step 2 from FIG. 30.

FIG. 33 is directed to page rewriting of the present invention.

FIG. 34 illustrates page rewriting as a two-pass process of the present invention.

FIG. 35 is a graphical illustration of the page rewriting process described in FIG. 34.

FIG. 36 is a blowup of pass 1 from FIG. 37.

FIGS. 37-39 give examples of how certain elements are handled in pass 1.

FIG. 40 describes instances in the page where the browsing tool rewrites URLs in the page of the present invention.

FIG. 41 illustrates how text is translated as part of the browsing tool of the present invention.

FIG. 42 is a blowup of the final stage from FIG. 30 for handling incoming cookies of the present invention.

FIG. 43 shows the Help button of the present invention.

FIG. 44 illustrates the restatement window of the present invention.

FIG. 45 shows an example of the interactive tutorial entry of the present invention.

FIG. 46 is a blow-up of the different types of the tutorials of the present invention.

FIG. 47 shows an example of warning lights of the present invention.

FIG. 48 shows how users' expectations and knowledge about the System are influenced through actual use of the System of the present invention.

FIG. 49 illustrates the tutorial daemon of the present invention.

FIG. 50 depicts the input length meter of the present invention.

FIG. 51 is an example of shortcuts of the present invention.

FIG. 52 shows example of emoticons of the present invention.

FIG. 53 is an example of the translator of the present invention.

FIG. 54 illustrates a number of personalization features of the present invention.

FIG. 55 illustrates the splash page of the present invention.

FIG. 56 illustrates the plurality of different features in the chat application of the present invention.

FIG. 57 illustrates the different features in the chat room of the present invention.

FIG. 58 illustrates the Help process of the present invention.

FIG. 59 illustrates the “current member's box” of the present invention.

FIG. 60 illustrates switching language zones of the present invention.

FIG. 61 is an overview of the browsing tool of the present invention.

FIG. 62 lists some of the browsing tool features of the present invention.

### DETAILED DESCRIPTION

In one embodiment of the present invention, a system (“System”) for electronically translating text includes an electronic language translator that receives source language text input and produces translated target language text. An interface is coupled to the electronic language translator and configured to provide a user with an option of viewing one or more target language texts with or without source language text. The electronic language translator translates the source language text to at least one target language at the time of submission of the source language text. An output interface outputs the target language text from the electronic language translator. The output interface can vary an interface representation of text in the one or more target languages.

The electronic language translator can include at least first and second dictionaries. The electronic language translator references the first dictionary and then the second dictionary in a process of translating source language text into one or more target language texts. The dictionaries are maintained in an application or customer hierarchy. A generic data format can be included that is independent of the translation engines, input interfaces and output interfaces.

In one embodiment, a conversion module converts the input source language text from the format for a specific input interface to a generic format. A routing module then determines which translator provides an optimal translation and then routes the text to that translator. A conversion module converts text from the generic data format to a specific input format. A conversion module converts a specific output format from the translation engine to the generic data format. A conversion module can be included to convert data from the generic data format into an output format suitable for an output interface.

The System of the present invention has a variety of different applications including but not limited to translation of text, real time translated chat, website content, e-mail, instant messaging, multi-lingual auctions and marketplaces, and the like.

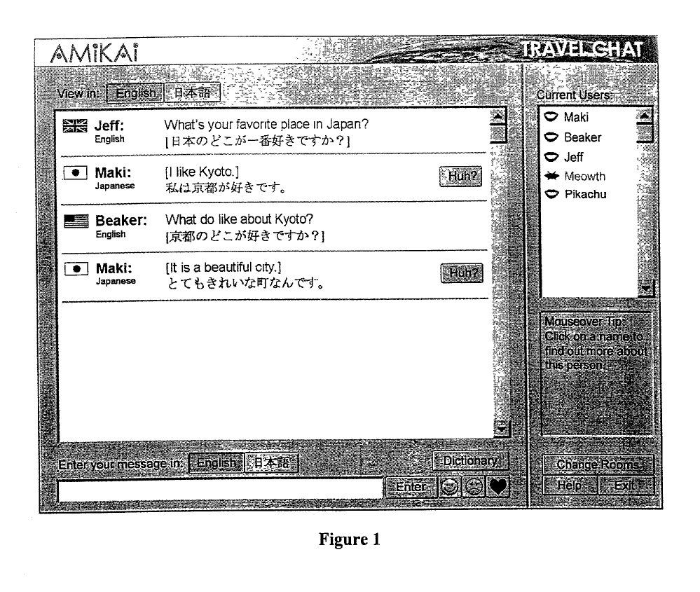

The present invention allows multiple people to engage in an online translated text conversation. Users can define their input and view languages and Chat applications of the present invnetion translates input sentences from one user to the appropriate output languages defined by each of the other users. A screenshot of a chat application of the present invention is illustrated in FIG. 1. In one embodiment, the present invention invention is for casual chat between users on a portal or community site, intra-company communication on a corporate intranet, business-oriented chat on a business-to-business exchange, and real-time customer support solutions, among other uses.

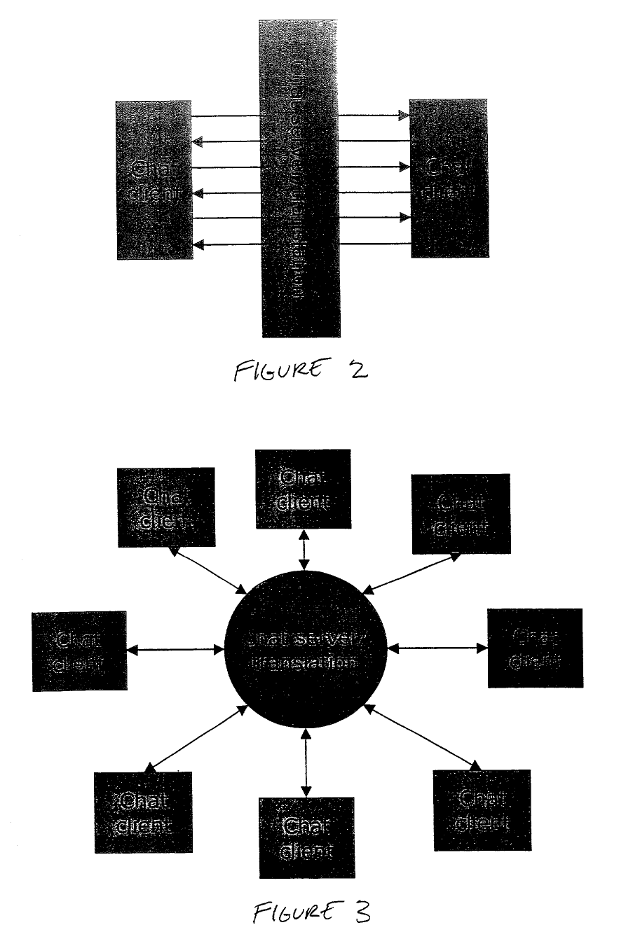

FIGS. 2-5 illustrate one emboidment of a real-time multilingual communication methods and apparatus of the present invention. FIG. 2 illustrates how different users use the method and apparatus of the present invention. Illustrated is a two-person interaction model. In this model, two people communicate exclusively with each other, sending messages back and forth. Each message is sent to the chat server, translated (if the message is textual), and relayed to the other user. The second diagram illustrates multiple-user communication where multiple people message each other in one room. In this model, every message that is sent by any one chat client is captured by the chat server, translated (if the message is textual), and rebroadcast to every chat client in the chat room.

FIG. 3 illustrates the several types of messages that travel within a chat room. One is a plain text message which is translated instantaneously into any of the chat room's supported languages. The next type is iconic. These are significant because when dealing with universal language there is a need to transmit messages that are understood universally. Another type of message is meta-transactional whose sole purpose is to facilitate the entire process of communication. One example of a meta-transactional message is the “Help?” message, which one user may send to a second user alerting him that she did not understand his message, and requesting that he restate it in a way that may be translated more effectively and thereby more easily understood.

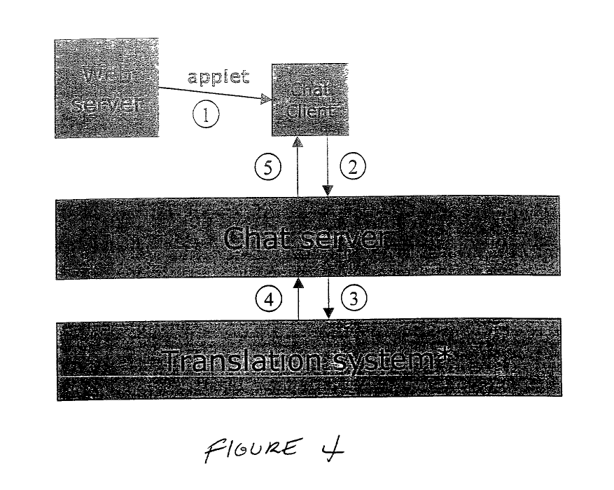

FIG. 4 is a high level overview illustrating operation of the System of the present invention. A user uses their browser to access the web server of the present invention. The web server delivers a page which contains an applet. The applet appears. From that point forward communication between the user and the System occurs exclusively through that applet. The user inputs a message in the applet which is sent to the chat server. When the message is textual, the chat server sends the message to the translation System, which translates the message and sends it back to the chat server. At this point, the message contains versions of the user-entered text in all the supported languages of the chat room. The server then retransmits the message out to all users in the chat room.

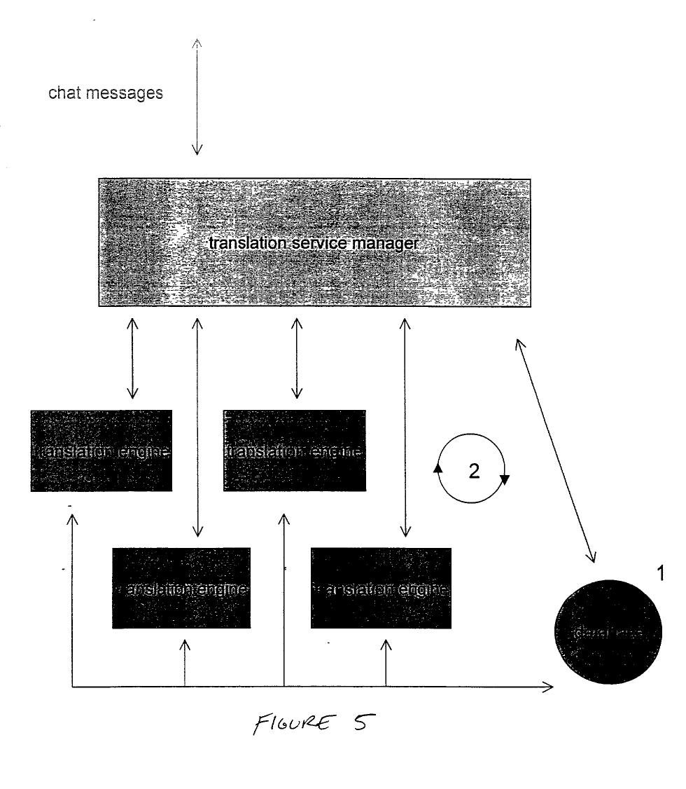

FIG. 5 illustrates the type of feedback that occurs. Throughout the process a feedback loop runs continuously. As messages are received by the translation System, there is interaction between 1) the database for storage of information of the messages, as well as 2) with the machine translation engines. The database stores our static translation cache, which contains many text phrases pre-translated across multiple languages. These translations are performed by humans and are thereby guaranteed to have perfect quality. In addition, the cache modifies itself over time by reacting to patterns it observes in the types of messages it receives. This results in higher translation quality. Text elements that are not handled by the cache, are sent to the translation engines for translation. Each box in the figure represents a single machine translation language direction, e.g. English to French. As a result, the translation System utilizes multiple translation engine components. Different providers can be used for different language pairs. Some engines can support multiple directions.

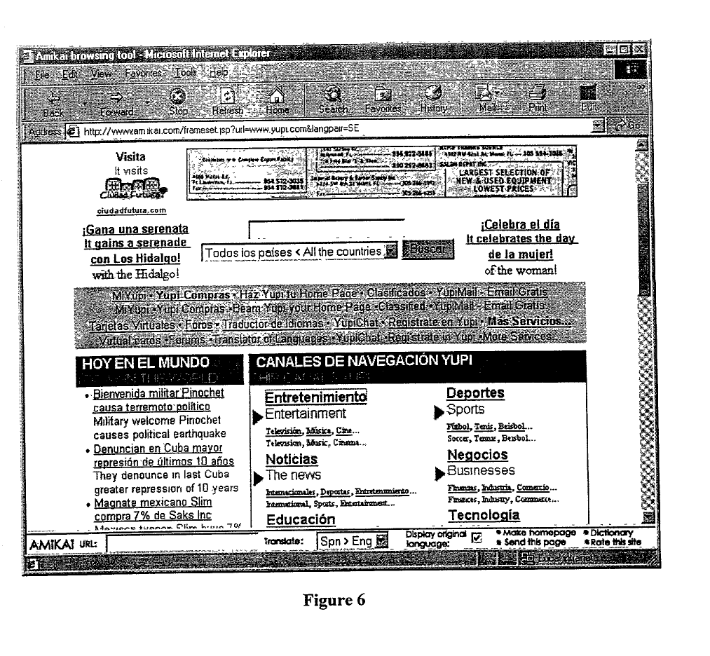

The present invetnion also provides a translated web browsing tool that provides machine translations of website content. One example is translation of all text on a website into a language defined by a user. The present invention also provides methods and apparatus that translate text embedded within graphics on a website. The browsing tool of the present invention can be useed both on an actual website and as a downloadable tool that plugs in directly to the user's browser. The actual tool itself includes a toolbar that resides on the top or bottom of the user's browser screen and gives the user functional control over the language of translation, the URL of the website the user wishes to access, as well as a number of other features such as a way to submit the current site for human translation. A screenshot of the browsing tool of the present invention is shown in FIG. 6.

The browsing tool of the present invention is primarily a tool that provides individual users with access to Internet content that they would not be able to access with the tool. Examples of applications of the browsing tool include but are not limited to education, entertainment, research and the like.

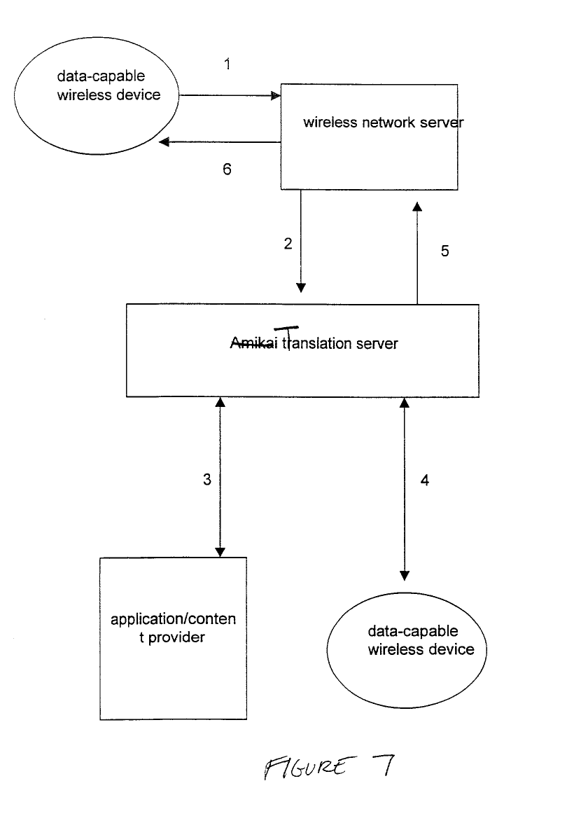

FIG. 7 illustrates data flow between the client wireless device, the wireless network provider, the data provider, and the translation services of the present invention.

Generally, the client wireless device is any personal mobile electronic device with a display/output apparatus, an input apparatus, and data transmission capability which is designed to serve as a mobile terminal for Internet and other network transactions. Examples include but are not limited to: cellular phones with data transmission and display capabilities, personal handyphone systems (PHS), personal digital assistants (PDAs), palmtop computers, and Internet/network capable appliances and devices. The wireless network provider is the data transmission infrastructure which allows the client devices to exchange data with each other and with any other devices accessible over the network. The data provider is any device which supplies either static or dynamic data to the client device over the data transmission infrastructure. The present invention acts as an intermediary in this data exchange, translating the data from one language to another as it passes from client device to data provider, from data provider to client device, or from client device to client device.

The wireless translation applications of the present invention are substantially equivalent to the internet translation applications. Some of the differences between the two include, the data is encoded in WML (wireless markup language), HDML, or some other standard for wireless data exchange, rather than HTML, the target end-user device is a data-capable cellular phone, personal computer, or other wireless data terminal rather than a desktop or laptop computer and the data is transmitted over the data network of the cellular service provider instead of/in addition to being transmitted over networks such as the Internet.

In a typical untranslated peer-to-peer transaction, a client wireless device may send a data transmission over the wireless data transmission infrastructure and network, where it is routed to another client wireless device.

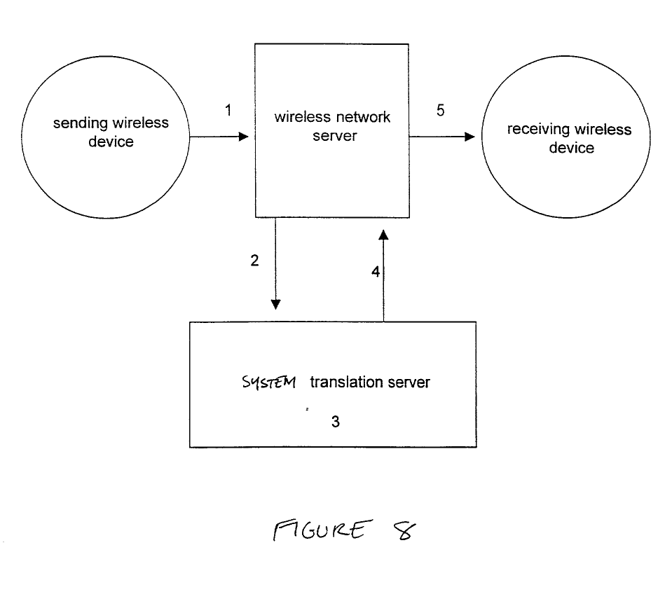

FIG. 8 illustrates a generic peer-to-peer data exchange where the translation service of the present invention acts as the intermediary in the data exchange. The present invention is integrated with the wireless data infrastructure and network. As data is sent from a client wireless device to another client wireless device over the wireless network server, that data is passed to the present invention which translates/processes/transforms that data and returns it to the wireless network server to be routed to the destination wireless device. Examples of data transmissions which fit this peer-to-peer model include SMS (short messaging system) messages, alphanumeric pager messages and the like.

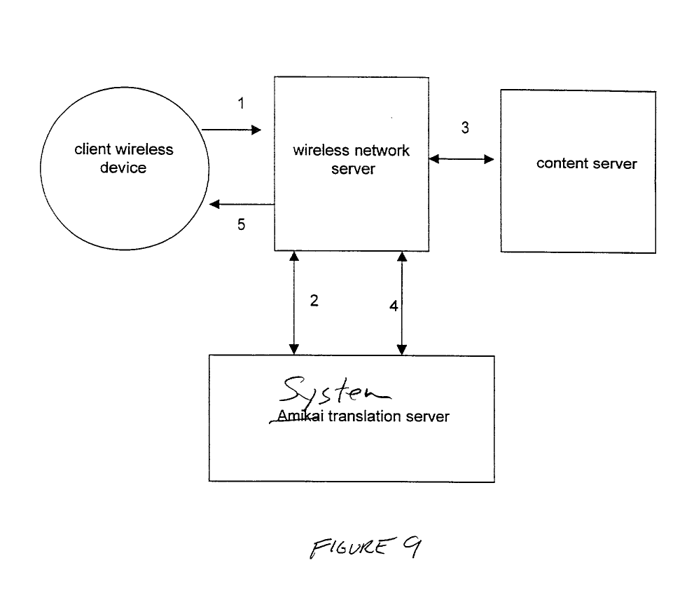

In a typical untranslated client/server transaction, a client wireless device may send a request for data over the wireless data transmission infrastructure and network, where it is routed to a data provider server. That server replies with the requested data, which is returned to the client wireless device over the wireless data transmission network. FIG. 9 illustrates a generic client-server data exchange, where the translation service of the present invention acts as the intermediary in the data exchange. A client wireless device formulates a request for data from a particular server; this request is then forwarded to the present invention. The translation service accesses the wireless data and services specified in the client request and translates/processes/transforms that information before returning it to the requesting end-user. Examples of this client/server model include WAP data browsing, server push data, and the like.

Further, the methods and apparatus of the present invention provide can provide draft quality translations of text emails. Users simply type their email in their own language and it is translated by into the target language of the person the email is being sent to. The translation can also take place on the side of the receiver, when someone receives an email in a language he or she may not be familiar with.

Instant messaging is designed as a communication platform for people who are accessing networks, including but not limited to the Internet, concurrently. When someone receives a message while offline, the message is stored for them to view the next time they log in to the Internet. Translated instant messaging can be used in corporate communication, customer service, student interaction, and any other situation requiring instantaneous communication across a language barrier.

The System of the present invention can include a multilingual search engine that allows someone who speaks one language to search for information on the Internet or on a specific site that is in a different language. A query can be entered in one language and the search engine of the System translates the query into the target language before searching for matching information. In another embodiment, the System also designs a mechanism that can resolve ambiguous search queries by asking the user for more input in potentially ambiguous situations. The multilingual search engine can be used to search for information on the Internet in general, or to search for a product or piece of information on a specific website or domain of information. Examples of potential uses include but are not limited to searching for a certain type of business outside of a country on an informational website, searching for a certain type of product on a foreign ecommerce site, or searching the entire Internet for websites related to a certain topic that are written in a language not native to the user.

Methods and apparatus of the present invention can tie in directly with online auction and marketplace sites. This solution allows users of the marketplace or auction to post messages or product descriptions in such a way that they are easily viewed and translated into a number of different languages. Form fields and drop-down menus can be used that limit the number of choices a user has when describing a certain product. This allows for storage of the posted information in a format that can be easily transferred to any language.

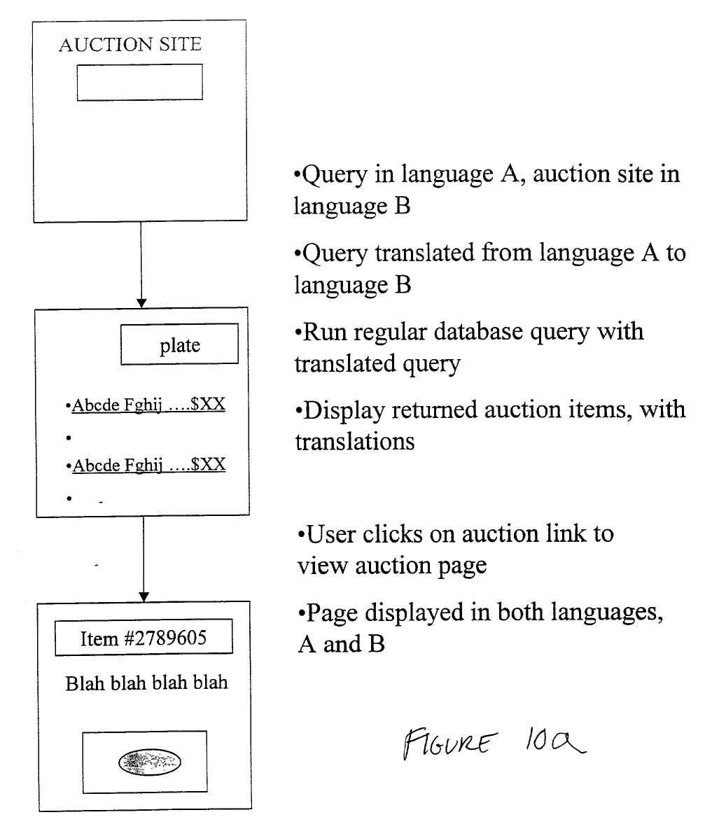

FIGS. 10(a) and 10(b) are directed to an auction tool embodiment of the present invention which combines features of the multi-lingual search engine and the browsing tool A user can enter a query in Language A, even though the site itself is in Language B.

For example, a user could enter in Japanese “osara” which means plate. That gets translated into the proper language; in the case of an English-language site, “osara” is translated into “plate.” The regular query is run on the auction site's database. From the auction site's side the interaction is the same as a regular, monolingual search. They haven't changed their processing at all. The pages that are returned are translated by the System of the present invention and the links are shown along with the translated version of the links. When a user clicks on a link to see the actual auction, the auction page comes up and is completely translated.

The auction site does not have to change its database lookup or change the pages they push. All of the translation management, including preparing text for translation, executing translations, and displaying translated versions of pages is handled by the System, and is completely transparent to the auction site.

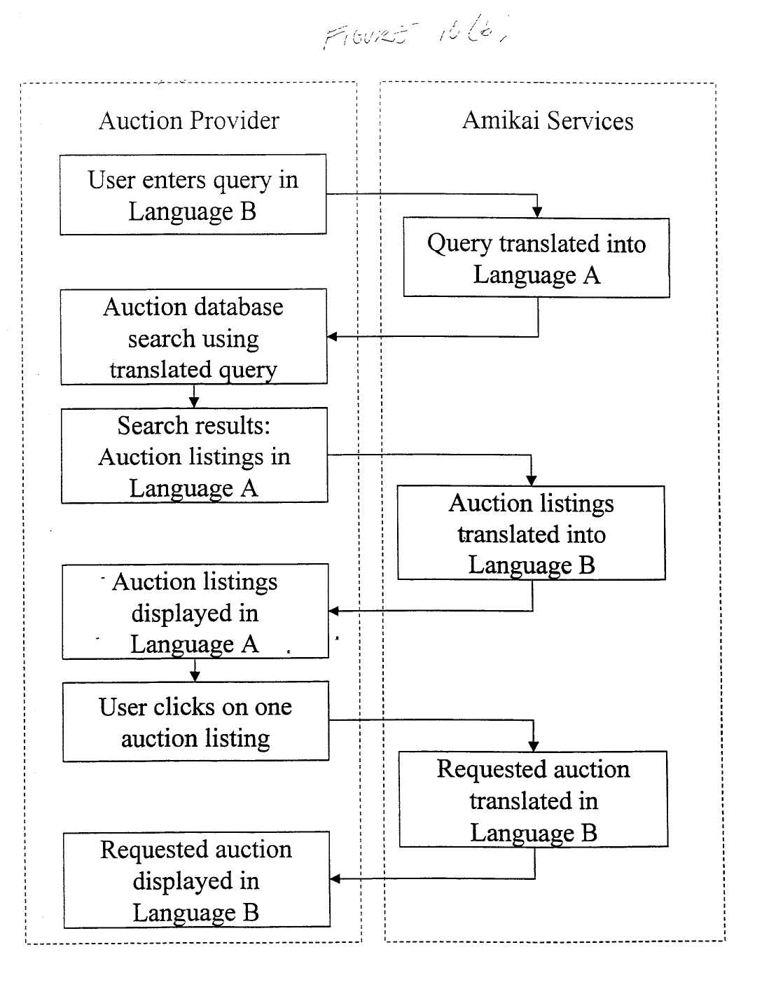

FIG. 11 shows the dynamic translation cache, which records recently translated sentences and is dynamically updated with each translation call. When a translation is requested, the dynamic translation cache is consulted first to see if the requested sentence was translated recently. If so, the recorded translation can be returned immediately, saving time and processing cycles on the translation engine. This is significant for many applications of the translation System, but in particular for the auction tool. In auction searches, users will often enter successive queries that are very similar to each other, varying the keywords only slightly. This causes the same auctions to be returned repeatedly. The present invention capitalizes on this repetitive behavior with a dynamic cache that keeps a record of all the recent translations. This is done in a manner similar to the common phrase table, and similarly takes advantage of the characteristic repetitions in the application's language use.

In another embodiment, the present invention integrates translated text and translated search into a product, allowing users of the marketplace or auction to search for goods and information in multiple languages. The results can then be displayed in their own language.

Along with the specific features needed to multilingualize an auction or market site, the present invention also provides users with custom dictionaries and common phrase lists tailored to their particular applications. This is especially effective where translations relate to a limited topic area, such as for a specialty goods auctions site.

Users can have direct access to the System, web-sites and interfaces of the present invention. Additionally, the System of the present invention permits users to act as hosts.

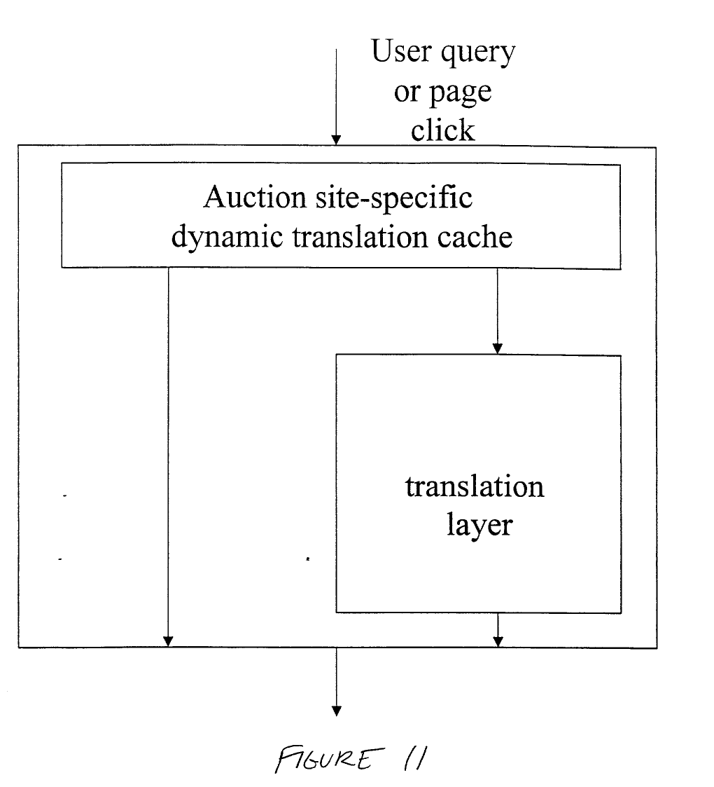

Referring now to FIG. 12, the framework of the present invention is illustrated and includes an interface, distribution and translation layers. A user uses the interface layer to construct an initial input and view the translated output as the user engages in multilingual communication. Each application can have a unique interface that maximizes the effectiveness of translated communication in a particular domain. In one embodiment, the methods and apparatus of the present invention utilize Java-based input and output interfaces. However, the present invention can also integrate with user interfaces of existing business applications, making it easy to empower existing applications with the capability of multilingual communication.

In one embodiment, the present invention provides outpt interfaces that differ among applications, can be primarily Java-based, and handle output in all supported language pairs. The output interface displays languages even to users who do not have an operating system that is native to the language of the output. To do this, the System can utilize all Java Unicode character strings. Depending upon the user's system, it may request that the user allow a short procedure that installs appropriate fonts and writes to certain configuration files on the user's system. This installation procedure enables the user's system to display fonts that are not native to their operating system.

After the input is received the interface layer forwards the request to the distribution layer for further processing. The distribution layer serves as a conduit between the user Interface and the translation layer. Specifically, the distribution layer provides language pair distribution, load balancing and is a common interface to the translation layer. For language pair distribution, the distribution layer ensures that the translation queries are passed on to the correct translation engines of the System based on the language-pair of the translation request. The Distribution Layer utilizes a load-balancing system that manages the load of each instance of the translation engines. For every language pair, the System of the present invention can create multiple instances of the translation engine. The Distribution Layer ensures that the queries are distributed efficiently among the different instances of the engine. As a common interface to the translation layer the interface layer will vary depending on the software application. Applications with widely differing user interfaces can all utilize the translation layer in the same manner.

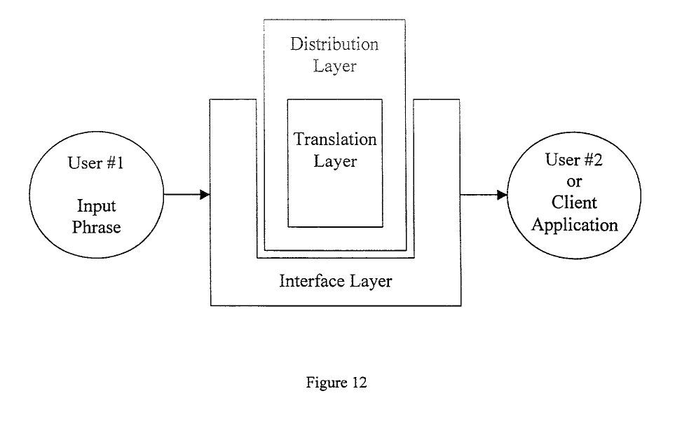

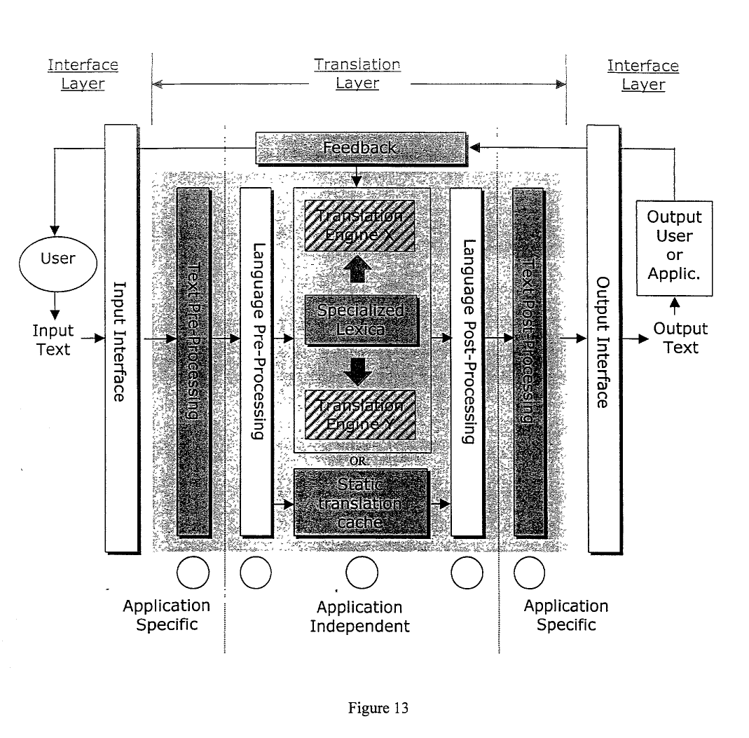

Translation is performed at the translation layer which can include the five steps illustrated in FIG. 13. Procedures that each step undergoes are more fully explained in FIG. 14.

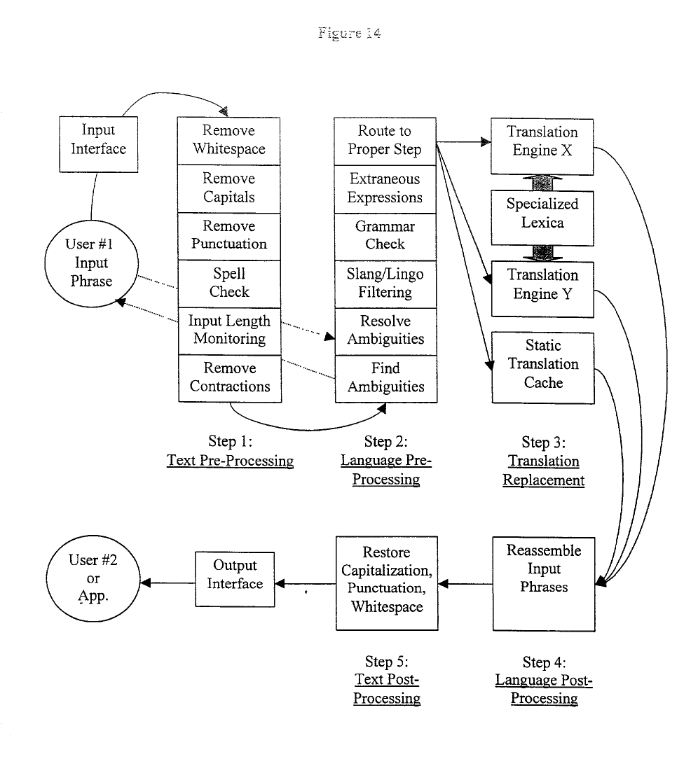

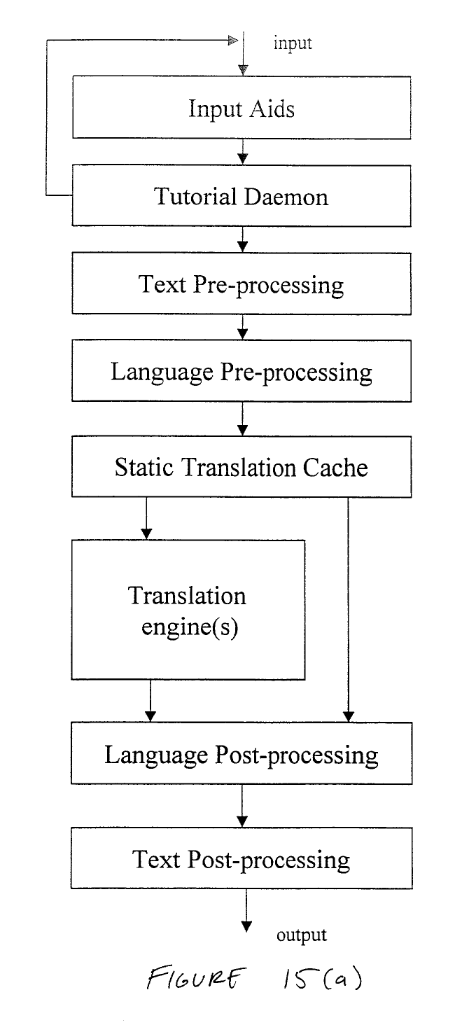

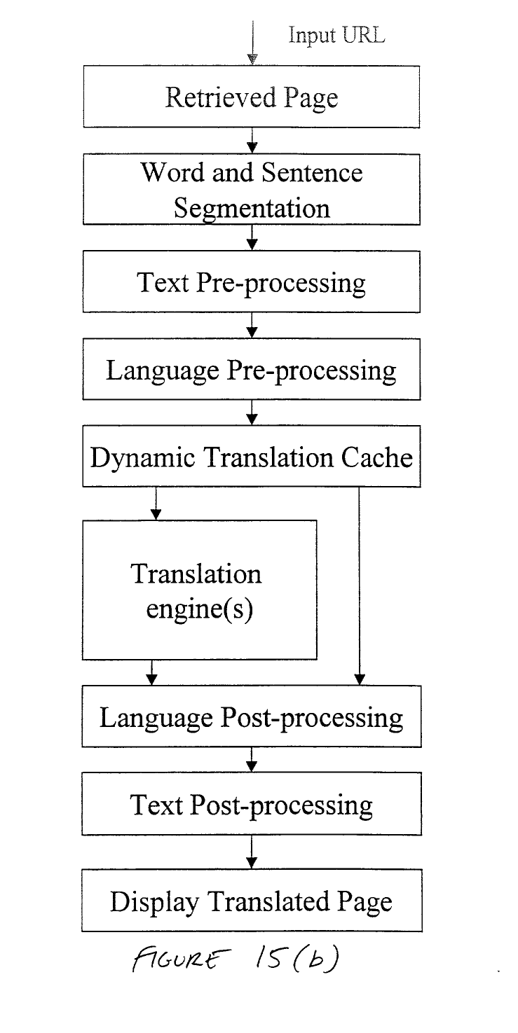

FIGS. 15(a) and 15(b) illustrates the full linguistic processing that occurs in the chat application specifically. As the user inputs something a series of input aids are available to help the user type in inputs. For example, typing in Japanese is very slow. There is tension between the desire to type and input as fast as possible especially in the chat application, while at the same time making the input language as clean and proper as possible for the translation engine. The method and apparatus of the present invention minimizes the problems of monolingual input, which is usually too poor quality to translate well. This is achieved by providing a series of tools that draws a balance between the two extremes of fast input and strictly grammatical language. Further detail on input tools is given in FIG. 16.

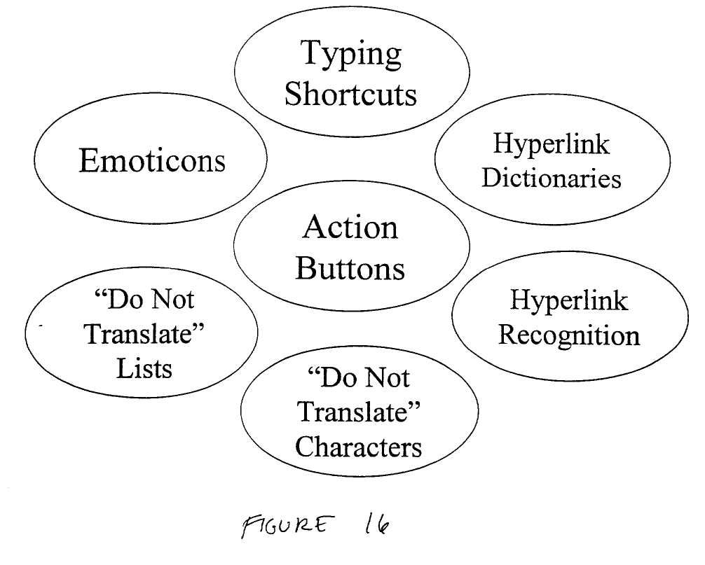

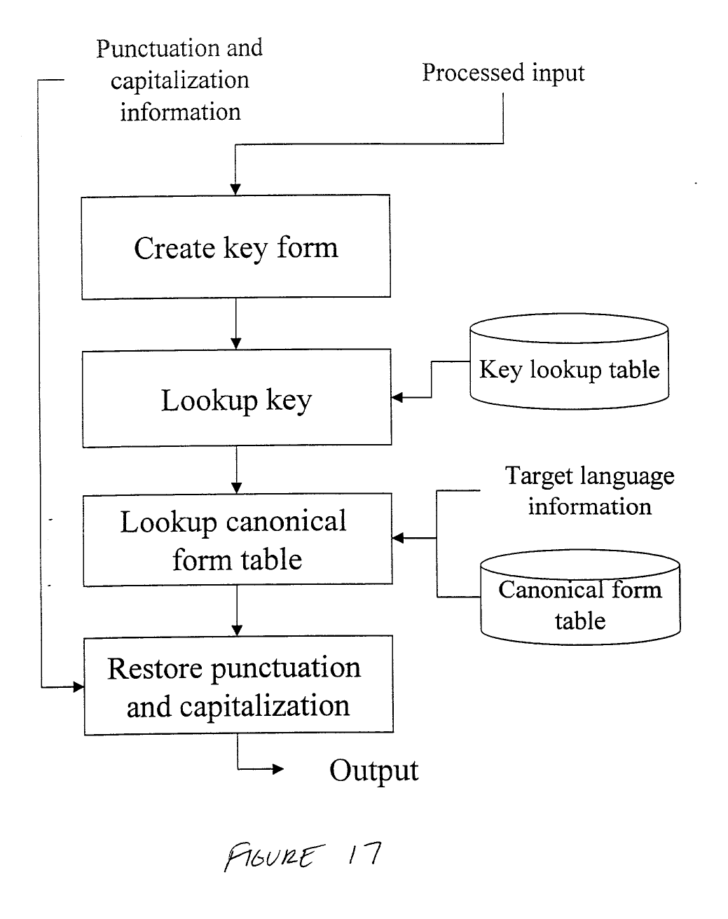

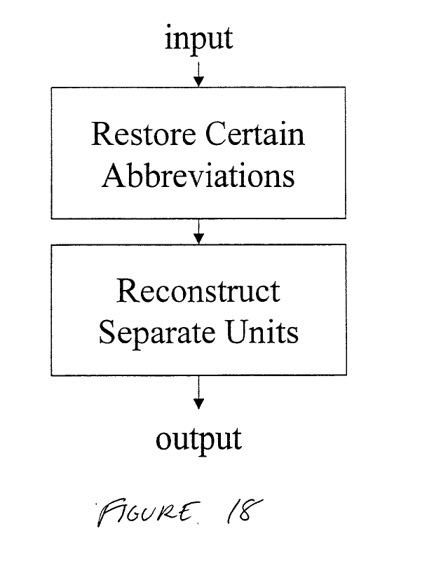

A static translation cache, also called a common phrase table, is provided. This includes phrases that are frequently repeated in chat applications (or whatever the specific application of the machine translation is); the phrases are stored with perfect translations. Items in the cache go directly to post-processing without going through the translation or other engines. Further detail on the static translation cache is given in FIG. 17. Finally, there is some post-processing. Further detail on the post-processing is given in FIGS. 18 and 19.

In step 1 the text input is converted into a state that can be translated. Text inputs differ among applications. It is important for every input be distilled down to a form that can be synthesized by subsequent steps which are application-independent. Therefore, step 1 is application-dependent. In step 1, the following actions occur: unnecessary whitespace within the text are removed, improper capitalization are removed, which are later restored in step 5, excess punctuation is removed, again restored in step 5, the input is spell-checked, the input is grammer checked. Certain contractions are removed from the input. In the case of translated HTML browsing for the translated browse feature of the present invention, the pre-processing operates differently. There, the pre-processing step handles the task of parsing the HTML, preparing the appropriate text for translation, and then reformatting the resulting translations while preserving the form of the original HTML page. The text pre-processing step for HTML translation is described in more detail further below. As this pre-processing step distills the input, it retains information about the input's original state that is later restored to the translation in Step 6, as the translated output is produced.

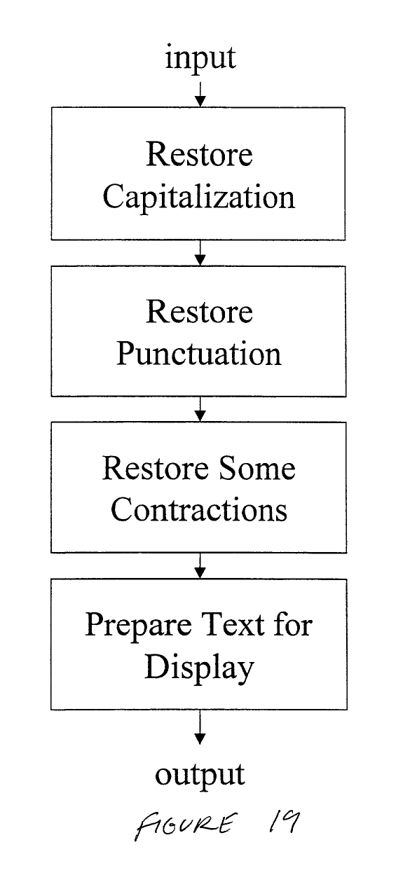

FIG. 20 illustrates text pre-processing. Text pre-processing can remove white space, remove and retain capitalization information, remove and retain punctuation information, and rewrite contractions.

In step 2 the input is analyzed for special linguistic structures such as synonymous words, extraneous expressions and common phrases. This is also the level where the System will examine the input for any potential ambiguities that the user would need to resolve. In cases such as translated search, where the System employs a feedback to the user mechanism, any such ambiguities would be resolved at this level before the input passes to the next step. After performing the linguistic analysis and determining what phrases need to be translated, the language pre-processor determines what calls to make to step 4, as well as which of those calls to make to the static translation cache or to the translation engines, as described below.

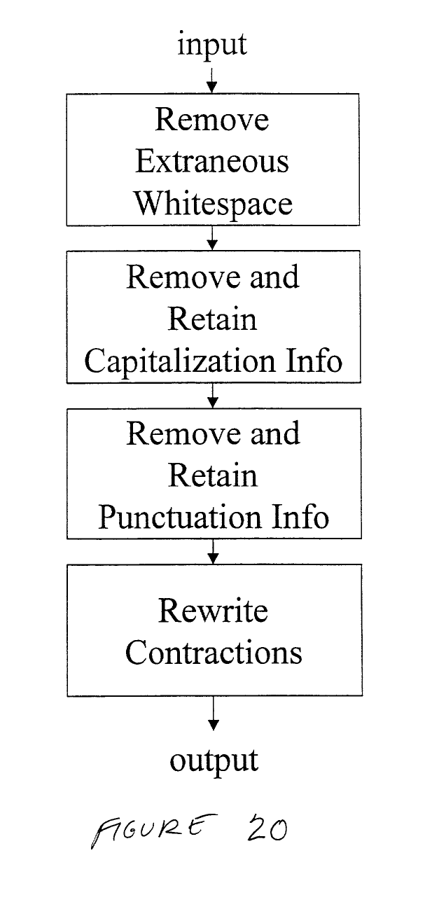

FIG. 21 is a continuation of FIG. 20 illustrating the language preprocessing. This includes removing extraneous expressions (such as “well” or “so”), rewriting slang, rewriting abbreviations, and dissecting compound phrases into analyzable units.

The text pre-processing and language pre-processing described in FIGS. 20 and 21 includes (but is not limited to) the following specific steps:

Remove capitalization, preserving the information;

Remove punctuation, preserving the information;

Standardize spacing;

Remove commas, hyphens, and other sentence-internal punctuation for cache matching;

Parse out names of other users from beginning or end of sentences;

Parse out connecting words and expressions such as “well,” “oh,” “ah,” “well then” (English), “pues,” “si” (Spanish), “eh bien” (French), “,” “ ” (Japanese), etc.;

Attempt to chop sentences at commas and semicolons to match each half with cache;

Attempt to correct common spelling errors for cache matching;

Expand contractions, preserving data (English, German, French);

Rewrite abbreviations for cache matching, e.g.

“r”=“are”, “4”=“for” (English)

“2”=“de”, “9”=“neuf” (French)

“k”=“que”, “t”=“te” (Spanish)

Add dropped from, (Japanese);

Chop off ending particles (“gobi”) (Japanese);

Expand to, (Japanese);

Attempt to drop accents for cache matching (French, Spanish);

Use alternate spelling for cache matching (German).

Step 3 is where the lowest-level translation occurs. Depending upon the content of the text input, the translation step employs one of two subsystems:

### Static Translation Cache

In this embodiment, a translation cache stores commonly submitted inputs and their translations for extremely fast lookup. The motivations for the static translation cache are, translation quality, speed and scalability. By utilizing a cache, the present invention is able to specify perfect translations for a large number of the most commonly submitted text inputs. Such inputs include colloquialisms, slang and common phrases in each language, as well as specialized phrases that are common in specific client applications and industries. By accumulating commonly accessed inputs and their translations in a high-speed cache, the present invention increases the speed of common translations and thereby improves the user experience. By minimizing the number of calls that the System of the present invention makes to the translation engines, scalability and stability are improvided.

The cache functions by grouping phrases that have similar meanings and then associates a single canonical phrase with each group. When performing a translation on any of those phrases, the cache returns the translation of that canonical phrase. The cache includes a database table of canonical phrases across all supported languages and a series of hashtables for each supported language. These are canonical phrases that have a version in every supported language. For example, the expression “Hello” is universal and has a version in all languages. Each hashtable stores phrases that may not have exact equivalents in the other languages, but can be approximated to one of the canonical phrases in the first table. The key of the hashtable is the common phrase, and the value is an index to the row in the first database table with the equivalent canonical phrase. Because the text has been pre-processed and distilled prior to handling by the cache, the lookup is not disturbed by minor textual differences in the input such as extra spaces or inadvertent punctuation.

In chat applications a large number of common phrases, including but not limited to greetings, frequently repeated phrases, and chat lingo are stored in a table that lists translations for each of the phrases. This ensures fast, completely accurate translations for the most common phrases which people use in the chat environment. The phrases stored in this master table are called canonical forms. In addition, variants of each of these phrases in each language so that these will be recognized as well. These variants include contracted versions, versions with extraneous, non-content-bearing words (“Hello” vs. “Hello there”), and synonymous expressions (“I'm well” vs. “I'm fine.”). The variants are stored in a standardized format called a key with all letters are downcased, punctuation removed, and spelling standardized to ensure that the widest range of user input will be recognized.

FIG. 17 illustrates the common phrase table with the static translation cache. The processed input is received, and then converted to a key form by removing particulars of language usage. (This process includes many of the steps described in FIGS. 20 and 21.) There is a look up in the key table to see if the input is a common phrase. The key table then gives a reference into the canonical phrase table, which gives the output translation of the input in the appropriate target language. Punctuation, capitalization information, and the like are then restored.

### Third Party Translation Engines with the System of the Present Invention

For text inputs that are not stored in the static cache, the System of the present invention sends the input to an appropriate third-party translation engine for processing. The present invention utilizes several translation engines to ensure that the quality of translation is optimal for each supported language-pair and treats each third-party engine as a virtual black-box. Different engines have different capabilities. A custom Java wrapper is written to each engine, which serves as a common API so that previous steps do not have to understand or interact with each engine's unique API. Each engine instance handles a single language pair and produces for each text input one translated output.

Each third-party translation engine is treated as a distributed object and communicated by using the RMI protocol. The System of the present invention utilizes multiple instances of each translation engine running on numerous machines to minimize dependence upon the stability of any one single engine instance or machine. Further, the System of the present invention can be scaled simply by adding additional machines and connecting them to the distribution step, described previously.

Because of the ambiguity of language, the quality of an MT engine's output is highly dependent upon the quality and relevance of the lexica it utilizes. To improve the quality of output lexica for each language is compiled for numerous topic areas, and the appropriate topical lexica is applied to each communication domain. For example, in its business chat rooms, the translation engines employ business-related lexica, whereas its sports rooms use sports-related lexica.

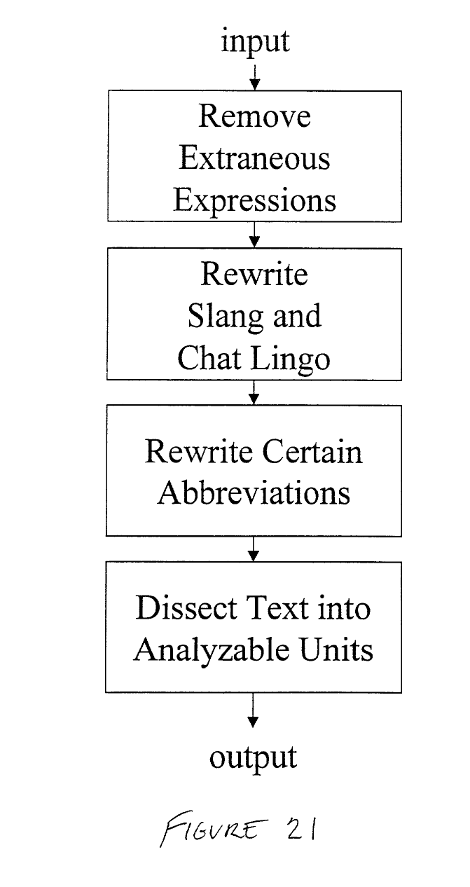

FIG. 22 illustrates the translation engines with proprietary dictionaries of different types. These include topic specific dictionaries appropriate for the topic of the chat room, website, or other current application, proper name and proper noun lists that the method and system of the present invention frequently update to make the translations in each application as current as possible. Users are also able to make their own dictionaries.

In step 4 the various fragments of the original input are reassembled after having been split apart in step 2. Some parts of the input may have passed through a translation engine, while others were routed to the static translation cache.

FIG. 18 illustrates the language post-processing (restoration) stages where separate units are constructed and text is reconstructed. This is includes restoring certain abbreviations and reconstructed units that were separated during the language pre-processing in FIG. 21.

Step 5 restores the textual changes that were made to the input in step 2.

In FIG. 19, text post-processing (restoration) occurs with punctuation, contractions, and capitalization restored as appropriate. This step generally restores the information extracted in FIG. 20. The text is then prepared for display and output.

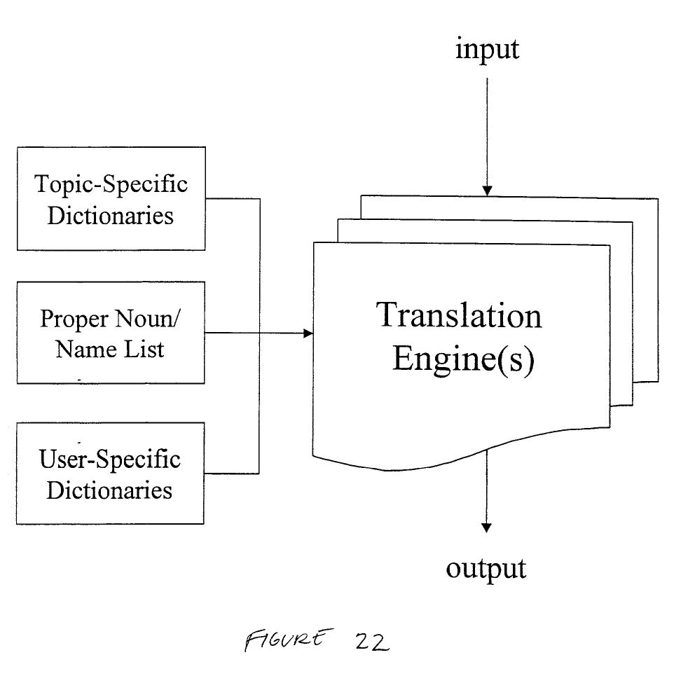

The translation layer includes customized dictionaries. One type of customized dictionary is topic specific where the topic is specified either automatically by the topic of the chat room, or manually by the user as he/she uses the browser or search engine as illustrated in FIG. 23. These topic-specific dictionaries include ones provided by the translation engine itself.

The dictionaries of the present invention improve the level of translation for specialized topics. Additionally, for general translation language and topics of the dictionaries are maintained topical and current.

The present invention updates a dictionary of proper nouns with their correct translations or transliterations for all necessary language pairs. In the chat setting, this allows discussion of the most current topics. In the browser and search engines users will are able to keep up with the fast-moving nature of web sites on the Internet.

The translation layer also includes user specific dictionaries. Users are also encouraged to assemble personalized lexica. These allow users that use specialized language not handled well by general dictionaries to specify the desired translations. Users that have familiarity with a language other than their own can build this dictionary directly. If a user lacks this ability, the present invention invention provides a tool for speakers of two different languages to specify jointly the proper translation of a term for the dictionary. In addition, a second feature allows a person to store a word in his/her personal lexicon, notify a professional translator, and have the correct translation of the expression added to in his/her dictionary at some point in the next day or two.

The System of the present provides a filter that scans all input to the chat application for slang, idioms, chat lingo and problematic constructions. The filter expands or rewrites these specialized phrases to expressions in a form that can be better translated by the translation engine. The filters can be constantly updated to keep up with current slang and chat language

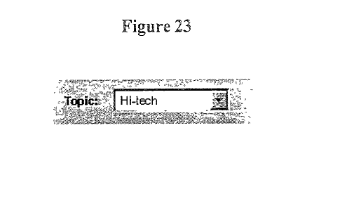

The present invention provides feedback to enable the users of the System to judge and respond to the quality of the translated output. There are four types of feedback produced and utilized by the System. These are illustrated in FIG. 24.

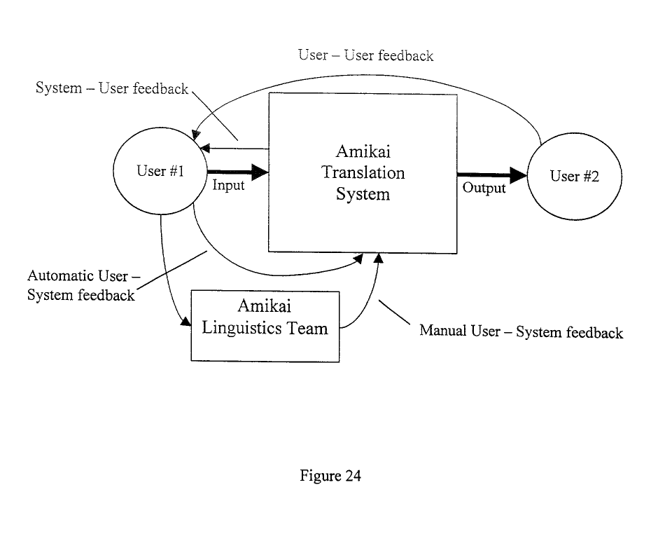

FIG. 25 shows the many levels of feedback which are incorporated in the translation System of the present invention. The System incorporates different type of feedback to improve the quality and usability of the translations.

User-User Feedback: The “Help?” button provides a mechanism for other users to say whether an input was translated in an understandable fashion. This is especially important for monolingual users who otherwise have no way of knowing whether their inputs are being translated correctly.

System-User Feedback: The System incorporates warnings, suggestions, and both static and interactive tutorials to actively educate users to use the translation engines as productively as possible.

User-System Feedback (direct): Users are able to direct the translations through a number of means, such as “do not translate” lists, “do not translate” markers in the input line, and user-defined dictionaries.

User-System Feedback (indirect): User activity directs modifications that the developers make to the translation System. For examples, users will report poorly translated words and phrases, and developers will also monitor user-defined dictionaries and “do not translate” lists to find items to add to the System dictionaries.

This feedback is important because many people are unfamiliar with machine translation (MT), and so the different feedback cycles help to educate users about the strengths and limitations of MT. In addition, the feedback provides mechanisms for users to control and personalize the performance of the MT engines, so this gives them a greater sense of control and allows them to view MT as a useful tool instead of something mysterious.

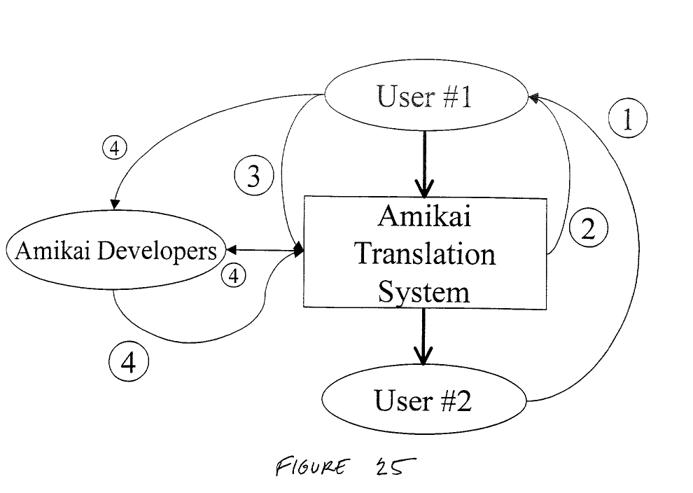

FIG. 26 illustrates the way the System educates the user about the MT engine, as well as about his or her own language. People believe that they are experts on their native languages, however most people have limited knowledge about their native language and how it works. The tutorial informs users about the elements in their language which are likely to be ambiguous or difficult to translate, such as slang expressions, idioms, and certain words and constructions (“got”, “se”, etc.) Interacting with the MT engine itself also shows users who understand at least some of the target language the strengths and limitations of the System, and helps educate them about the most productive use of the translation engines.

User feedback to other users is from the recipient of the translated output to the original sender. For example, a user who receives an incomprehensible message can tell the original sender that he or she did not understand the message. This immediately prompts the sender to rephrase the message in a form that can be more easily translated. A person receiving an instant message from a colleague, realizes that part of the translated message is not very clear. The receiver can immediately prompt the sender to rephrase the difficult part of the original message.

User feedback to the translation system is feedback that the recipient of the translated output gives to the translation System. Over time, as large amounts of translation data are accumulated, the present invention can use this data to improve the quality of the translation System. This can occur manually or automatically with the System. System feedback to the user occurs in a negotiated translation when the System and the user together attempt to resolve ambiguities in a translation. System feedback is especially critical when text entries are short as in search queries. When a user enters a query in one language whose meaning is ambiguous, the System can respond by prompting the user to select from a list of ambiguity resolving options. Without this type of feedback highly accurate translated search queries are not possible.

Text-processing step for HTML page translation is different from plain text translation. The present invention parses HTML pages, and provides placement of translations in the HTML page. There are two options for HTML page translation, show both original translation and show only the translation. When the original and translation are both shown the translations are preferably inserted into the original page without disrupting the form of the page. Tthe System then parses the HTML page and finds key markers which delineate appropriate locations for inserting translations. When only the translation is shown, the original text is replaced entirely by the translations.

FIG. 15(b) is similar to FIG. 15(a) with the same data path, but is for non-interactive applications such as the browser or auction tool. Wireless communication would also fall under this same grouping.

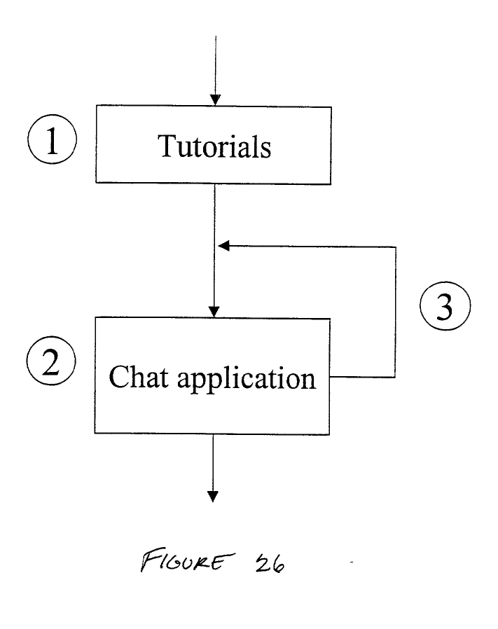

FIG. 27 describes the browsing tool on a high level as a three-step process: 1) the user makes a page request, 2) the request undergoes processing by our System, and 3) the System returns the response page to the user.

A user request consists of a URL and a language pair—source language and target language. The source language is the original language of the page, and the target language is the language that the page is translated into. The source language may become optional as a language identifier is incorporated into the browsing tool. The request may also include cookies previously set by the web site associated with the page request and other parameters, including but not limited to form parameters which can be forwarded on with the request.

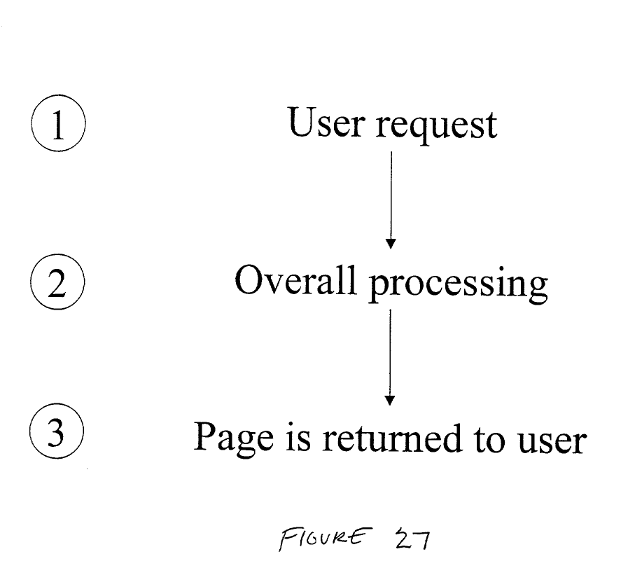

FIG. 28 is a high-level blowup of step 2 from FIG. 27. It describes the overall processing which occurs between the users' page request and the page response. Three steps are included: extract parameters from the user request, perform page retrieval and processing, and return the processed page within a dynamically-generated page.

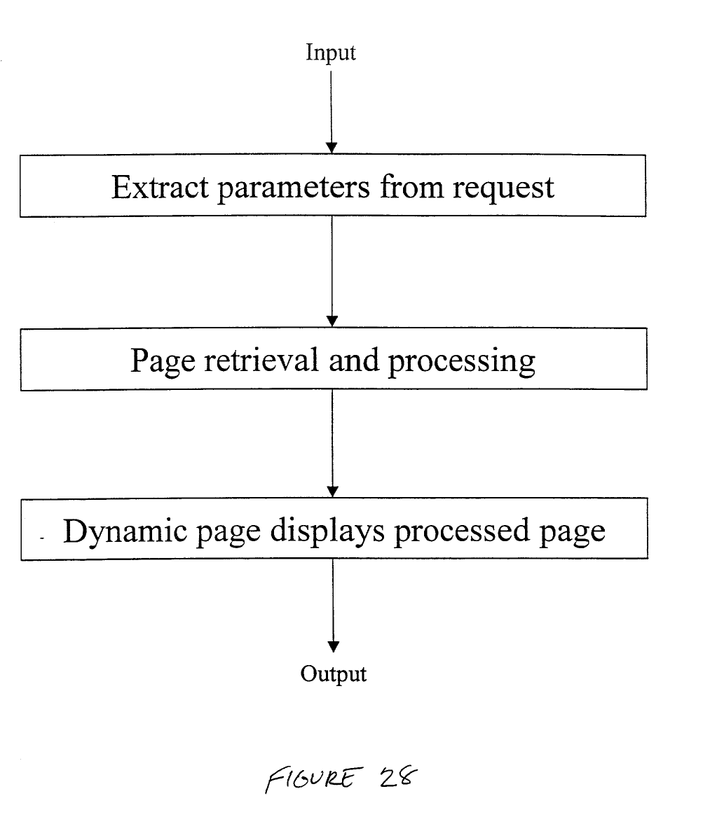

FIG. 29 provides more detail of step 2 from FIG. 28 for page retrieval and processing. There are three main types of page requests. The first is a user-specific page: These pages are never cached because it is assumed that their content is changing too often for them to be effectively cached. An example of such a page is a user profile page. They are always newly retrieved and rewritten on each new request. The second type is a non-user-specific page that has been cached. If a page is not user-specific and has already been cached, it is pulled from the cache and returned. The third type is a non-user-specific page that has not been cached or whose cache entry is out-of-date. These pages are newly retrieved and rewritten. In addition, they are stored in the cache for future queries.

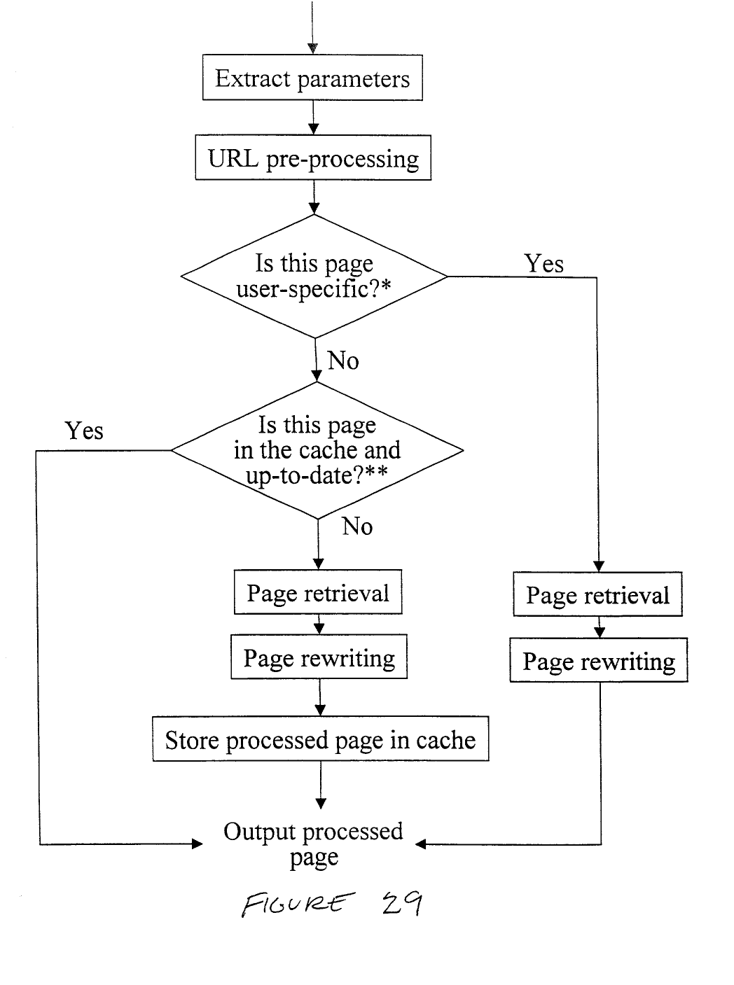

FIG. 30 is a blowup of page retrieval as represented in FIG. 29 In order to fulfill a user's page request the browsing tool of the present invention must first request the page from the source web site. In order to do this, it must first extract necessary information from the user's request, create a new second request, and then utilize this second request to query the source site. The page retrieval process consists of five steps:

1) Add parameters to URL. Here, any parameters contained in the user's page request are added to the URL of the second request.

2) Handle outgoing cookies: Cookies contained in the user's page request are forwarded to the second request.

3) Perform HTTP request on new URL: This is where the source site is queried.

4) Retrieve page: Using the appropriate character encoding for the page (based upon its language), the page is retrieved.

5) Handle incoming cookies

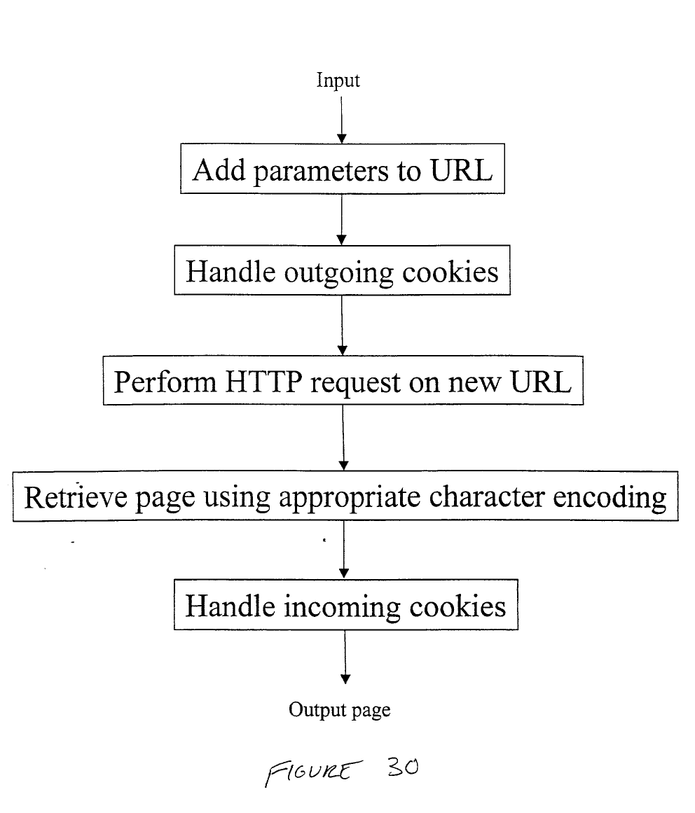

FIG. 31 is a blowup of step 1 from FIG. 30 describing how parameters are added to a URL before querying the source site. An important thing to note is that this process is language-sensitive. Specifically, when a user is viewing pages with source language A in target language B, parameters which represent user inputs are translated from language B to language A before being added to the page request. This enables the users to actively interact with pages that are not in their own language. For example, if a user is viewing an auction site whose source is language A in language B, and the user wishes to enter a search query in language B for a particular object, that search query is translated into language A before being submitted to the page.

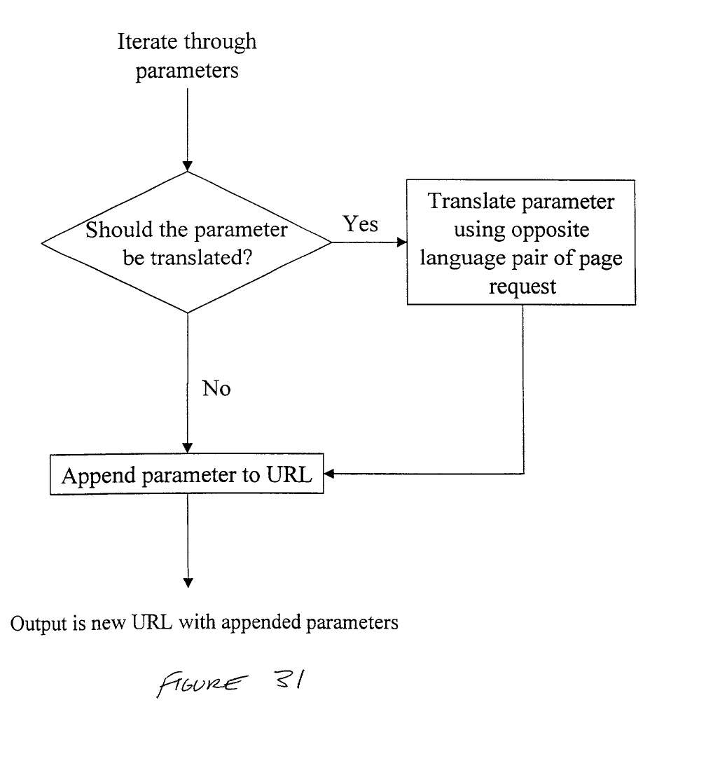

FIG. 32 is a blowup of step 2 from FIG. 30. Cookies which are passed in as part of the user request are rewritten to drop the path prefix of the present invention, thereby restoring the original path of the cookie, and the browsing tool includes the cookie when querying the original source site.

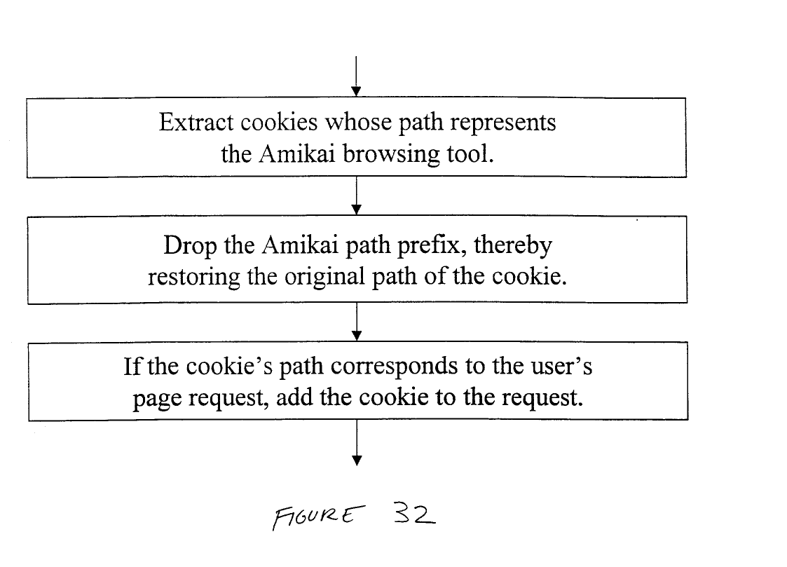

FIG. 33 is directed to page rewriting and illustrates why the browsing tool of the present invention is unique. The browsing tool kit enables the user to insert the translations inline, in order to view both the original text and the translation simultaneously. Additionally, the browsing tool preserves the look and feel of the original page. This is accomplished by carefully positioning the insertion of translations at strategic locations within the page so that they do not significantly shift or displace original content. While the page is made inherently longer, its overall look and feel is not disrupted.

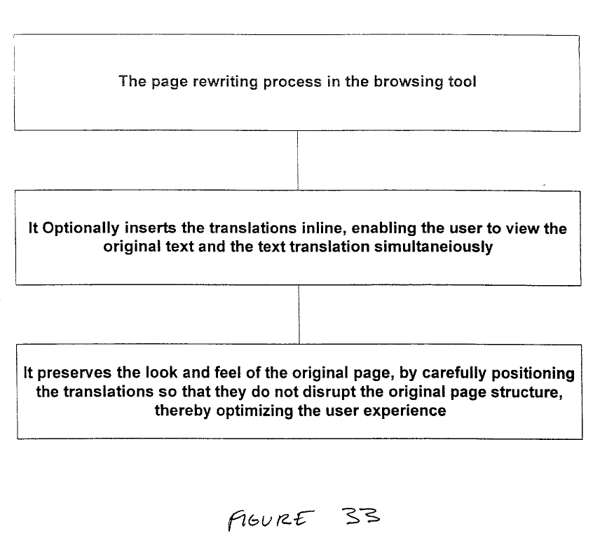

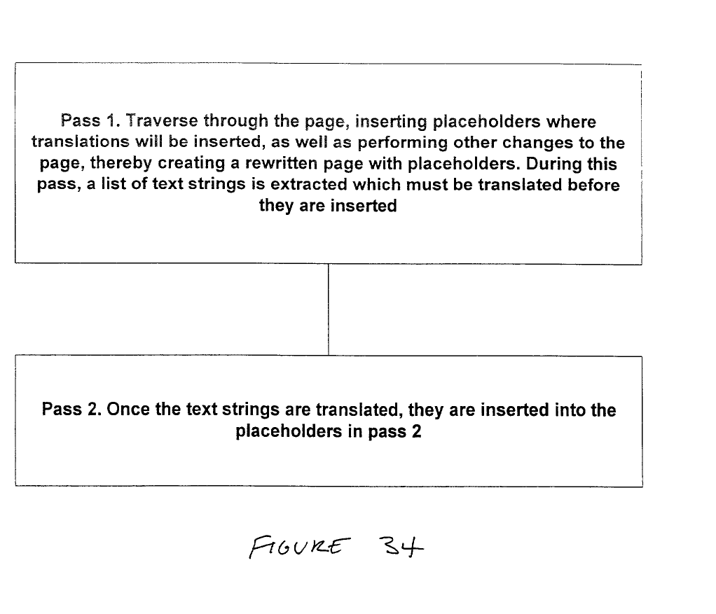

Referring now to FIG. 34 page rewriting is a two-pass process. In the first pass the page is traversed and translation placeholders are inserted in places where translations should be later added. Simultaneously, a list of text strings which must be translated is extracted. In the second pass the text strings which have at this point been translated are now inserted into the page, replacing the placeholders. FIG. 35 is a graphical illustration of the page rewriting process described in FIG. 34.

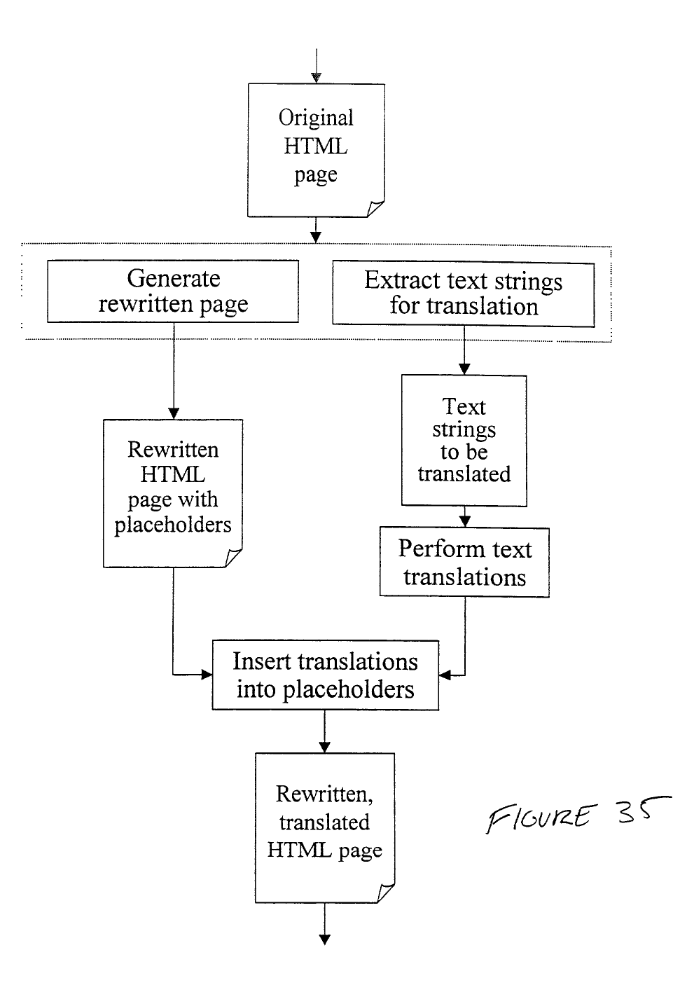

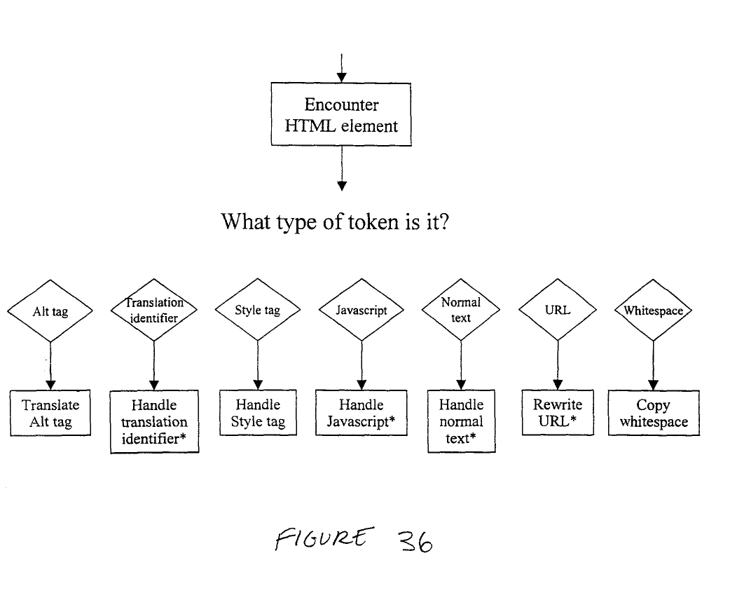

FIG. 36 is a blowup of pass 1 from FIG. 37. In pass 1, the HTML page is traversed and HTML elements are encountered. Each HTML element is handled uniquely. Certain HTML elements represent textual elements which require translation, while other elements contains links which must be rewritten. Still other elements require other handling. FIGS. 37-39 give examples of how certain elements are handled in pass 1.

FIG. 37 illustrates handling of normal text. Normal text is defined as text positioned outside of any HTML tags. Normal text is handled in two ways: 1) It is copied to the rewritten page, and 2) It is added to a cumulative text buffer to be later translated and inserted into the rewritten page. Both steps are required because the browsing tool displays both the original text and the translated text in the page. So the first step preserves the content and location of the original text piece. The second step causes the text to be translated and inserted into the page.

It is important to note that in the second handling step the text piece is added to a buffer and later translated and inserted into the page, rather than immediately translated and transferred to the page. In order for the translations to be inserted into the page in a way that does not disrupt the page's original look and feel, they must be strategically positioned. This requires that each text piece not be immediately translated and inserted following its original text counterpart, but rather that translations be grouped together and later inserted into the HTML page in an appropriate location. This results in a more coherent page and a better user experience.

FIG. 38 illustrates handling of JavaScript. When a JavaScript block is encountered: 1) it is scanned for text strings which require translation, and these strings are replaced with placeholders in the JavaScript; 2) these strings are translated; 3) the placeholders are replaced by the newly translated strings; and 4) the new JavaScript block is copied over to the rewritten page. Unlike normal HTML where the original text and the translated text are conveyed, JavaScript blocks only convey translations, since most JavaScript text strings represent single text elements which can only have a single value.

FIG. 39 illustrates handling of the translation identifier. Translation identifiers are HTML tags that signify the end of a contiguous chunk of text, representing a position where a translation of previous text should be inserted. When a translation identifier is encountered, the contents of the text buffer (described above for FIG. 37 and composed of text strings which are encountered within the page) are sent off for translation, a placeholder is added to the rewritten page and the text buffer is cleared.

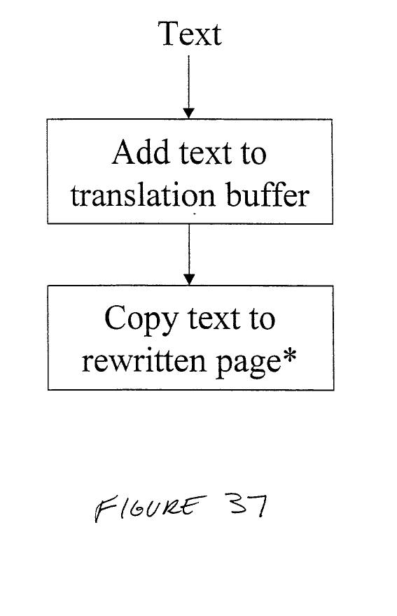

FIG. 40 describes instances in the page where the browsing tool rewrites URLs in the page. When URLs representing textual content are encountered, they are rewritten through the server of the present invention. URL rewriting ensures that as the user clicks through to subsequent pages, these pages continue to be translated as well. This provides a seamless user experience, allowing the user to browse and translate the web freely without any intermediate steps. This figure denotes specific cases where URLs are written to pass through the current invention. It is important to note that URLs are only rewritten if they represent textual content. URLs which represent other types of content, such as binary objects (images), should not be rewritten and should reflect the original source location.

The content of a URL is rewritten through the servers of the present invention., by changing the URL to pass through serves of the System of the present invention, and the original source location becomes a parameter which is passed to the servers. This parameter denotes the page which the user is requesting.

A relative URL is one in which the domain of the source location is not specified. With the present invention, the source's domain is added as a prefix to the URL, and then the URL is written as described in the preceding paragraph.

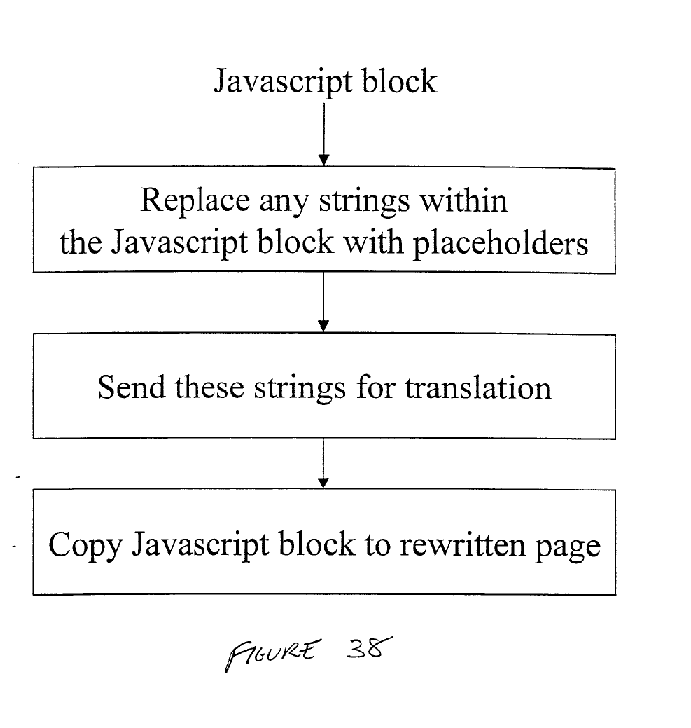

FIG. 41 is a blowup from FIG. 35 for text translation. FIG. 41 illustrates how text is translated as part of the browsing tool. Multiple individual text strings which have been encountered during the page traversal process are concatenated. A single concatenated string is passed to the translation engine, which returns a single translated string. This single translation string is broken back up into multiple translations and returned. This approach enables all the text on a page to be translated using a single call to the translation layer.

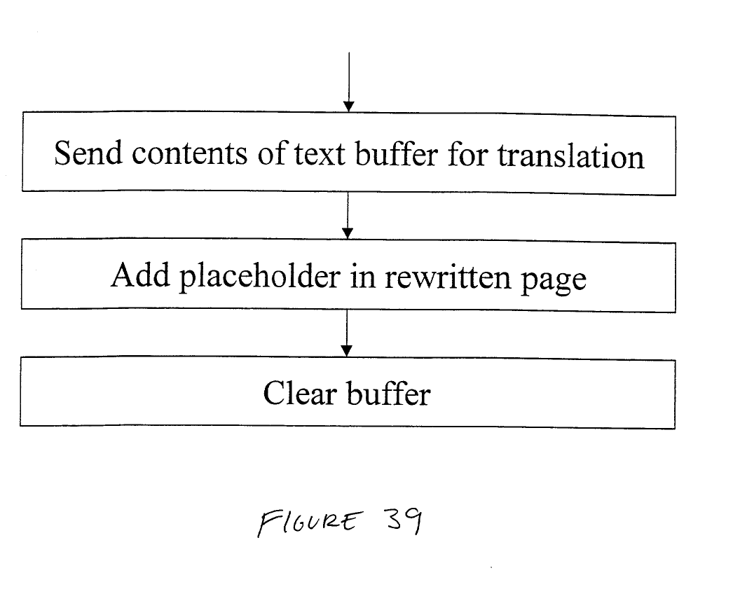

FIG. 42 is a blowup of the final stage from FIG. 30 for handling incoming cookies. This is the reverse of the process described in FIG. 32. Cookies which are returned from the queried site are rewritten so that their path passes through the servers of the present invention and are then inserted into the page response and returned to the user. This ensures that the cookies will be resent to the site whenever the user utilizes the browsing tool to access the same site in the future.

The HTML page translation process of the present invention performs the following steps:

(i) Performs text pre-processing on the HTML page, parsing the HTML page and producing a collection of text strings that should be translated.

(ii) Performs language pre-processing on each of these text strings. The language pre-processor determines what, if any, textual elements within each of these strings needs to be sent on for translation. For each of these to-be-translated strings, it separates them into two groups, “a” those that should be handled by the third-party translation engines, and “b” those which should be handled by the static translation cache. For those in group a, the language pre-processor concatenates all of these to-be-translated elements into a single demarcated string to the third-party engine in step 4. By concatenating all of these strings into one, it limits the number of calls to the third-party engine for each HTML translation. For those in group b, the language pre-processor makes individual calls to the translation cache for each textual element.

Upon receiving all translations from step 4, language post-processing occurs where the proper outputs are reconstructed. Text post-processing in step 6 then reconstructs the HTML page, inserting translations in the appropriate locations and thereby preserving its original form.

The System properly can handles HTML pages with Javascript, Forms, and Cookies. The resulting page then operates as the original with no change in functionality. Additionally, the System can use optical character recognition technology to recognize the textual content of images, and provide a translation for text embedded in images as well as pure HTML text.

In one embodiment, the framework is written primarily in Java, making it compatible with existing software applications and legacy systems. Because the framework is Java-based, it can run on any platform. The present invetnion can operate on Linux Pentium machines. The third-party translation engine can operate on a Unix, Linux or Windows NT platform on distributed machines.

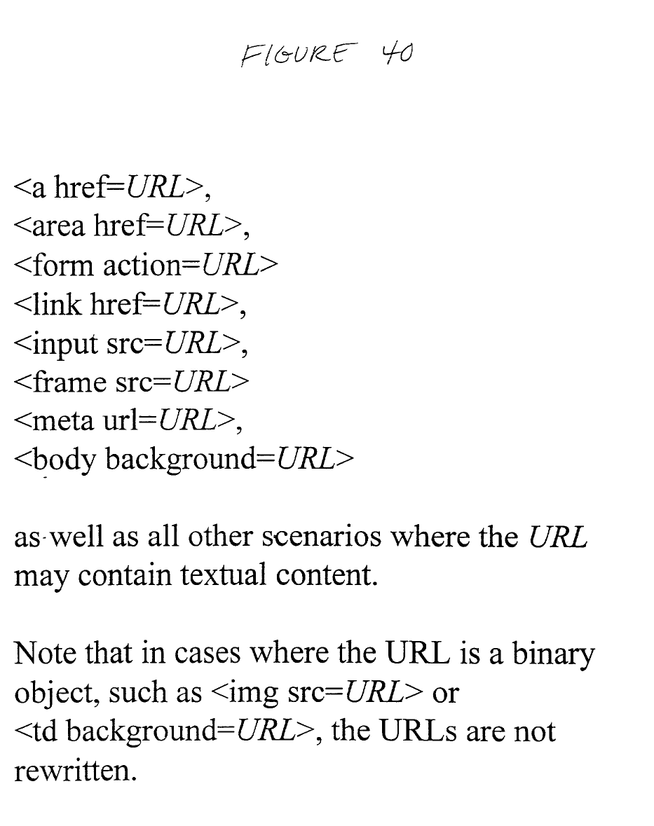

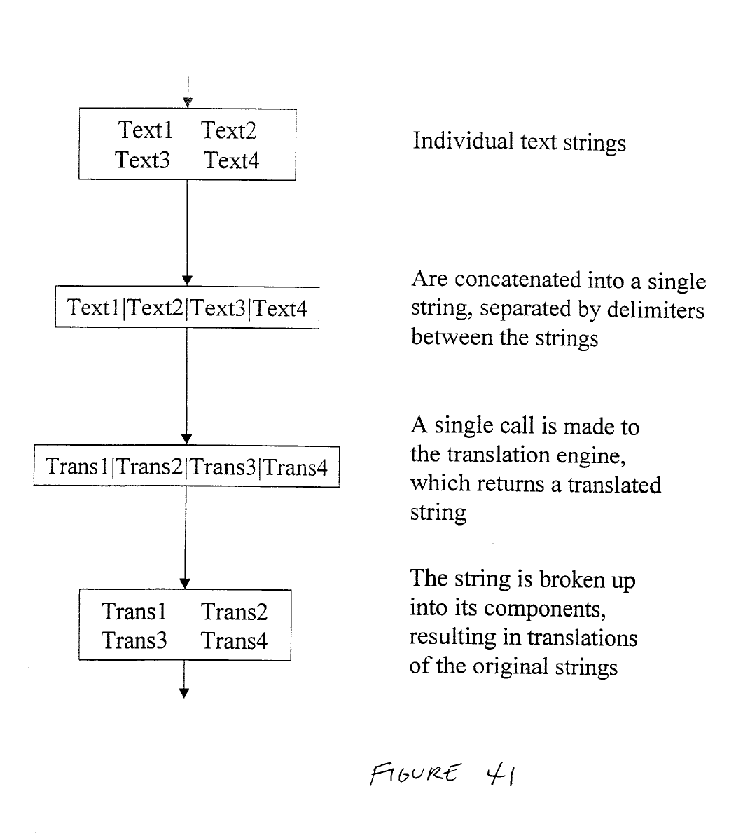

A “Help” butoom can also be provided. With the present invention, the use of translation within a chat environment is provides users to give feedback about the understandability of a statement's translation. This feedback takes the form of a button connected with each posted message called the Help button which other users can click to indicate an unclear translation, see FIG. 43. After the Help button has been clicked, the user that made the original statement is notified of the bad translation and shown a screen with an editable copy of the statement as illustrated in FIG. 44. This gives the user an opportunity to modify the statement to something more understandable for the System. In addition, the mistranslated statement can be sent through a grammar checker which can scan the input for a number of possible problems, including unparsable grammar, misspelled words, difficult-to-translate words or constructions, ambiguous words and the like.

One of the problems with most machine translation systems is that there is no incorporation of feedback to guide the translation. At numerous stages in analysis there are decisions that must be made, often about the resolution of ambiguities. For example, there can be ambiguities that are lexical, syntactic, semantic and pragmatic. A user can also confuse a translation system by using, (i) a word not in the lexicon, (ii) a construction that is not in the grammar and (iii) a known word in a novel way or with a novel meaning. Confusion can be unintentional and caused by misspelled words, poor grammar; incorrect punctuation and incorrect characters, particualarly in Japanese and Chinese.

For these ambiguities and confusing constructions, the Help button provides information about misunderstood sentences to the user and closes the feedback loop. This is done when another user does not understood the translation. Thus, the System of the present invention removes the burden of detecting the need for clarification from the computer. Furthermore, the System takes advantage of the communal nature of the chat room to allow users to help each other to find the best language for translation.

The Help button can refer to either the full user comment or to a phrase or word within the comment. In the case where just a single word or phrase is mistranslated, the other users can specify the specific part of the input which was confusing.

As the user browses the web the translated browser of the present invention can automatically provide translation sites without requiring the user to specify the source language of each site. This is done by implementing a language identifier that scans a page, guesses the language and then executes the proper translation automatically. In the case where the identifier guesses wrong, or the page contains multiple languages, the user can override this feature, By removing any necessity for the user to worry about, or even be aware of, the source language of the materials he/she is looking at, the present invention makes the browsing experience as seamless as possible.

The present invention can also provide a translation helper for the user. The translation helper is an interactive process with many functions including, instructing users on the proper use of the translation engine, helps users determine the best phrasing in order to achieve high-quality translation, and adjusts user expectations about the capabilities and limitations of machine translation. Users are trained to avoid these problematic constructions. This is done through both a passive approach, which attempts to provide instruction and information to the user, and an active element that reacts to user input to guide the user to better phrasing for translation.

Each user is encouraged to read a list of suggestions and instructions for the best language and constructions to use to produce the best translations. There is a separate list for each of the languages. The present invention offers a number of formats for the information which allow the user to choose the level of detail and the conciseness of presentation which best suits his/her tastes. The formats the user can choose from are:

1) A quick, bulleted list of points. This gives the basic information in an easy-to-read quick-reference format.

2) A longer README-style file. This format gives an expanded form of the information with longer explanations and good and bad examples to illustrate each point. The mascot is featured in amusing cartoons to make each point more memorable.

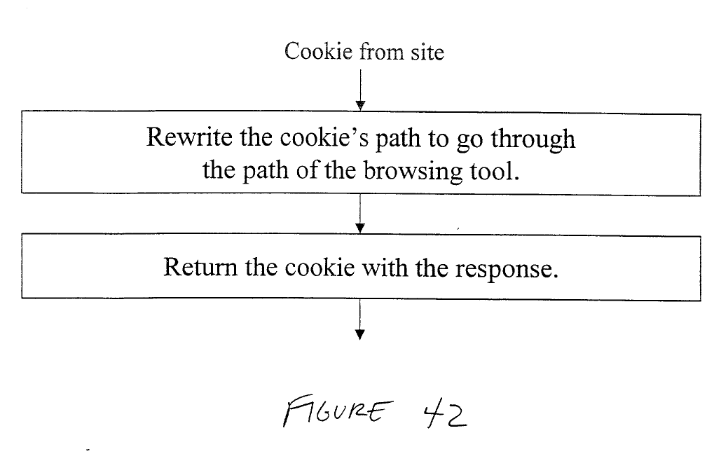

3) An interactive tutorial. In this version, the the present invention guides the user interactively through a number of examples to communicate the information in a fun, memorable way as shown in FIG. 45. The interaction includes illustrations, small quizzes, good and bad examples, and areas to test examples with the translation engine.

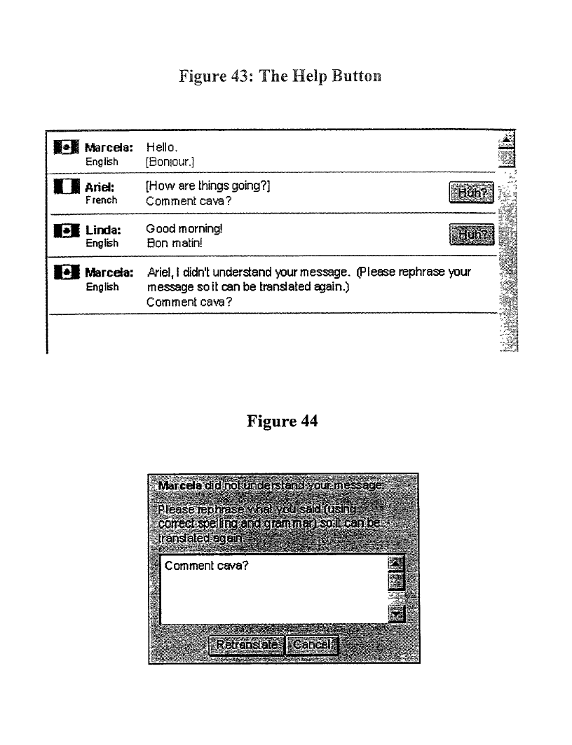

FIG. 46 is a blow-up of the different types of the tutorials, such as a quick, bulleted list of points, a more thorough tutorial with good and bad examples, illustrations, and explanations, or an interactive tutorial with quizzes, games, and translation test areas. The more elaborate tutorials make the learning experience more memorable and fun. The method and apparatus of the present invention provides a level of interactivity with the user to assist the learning process.

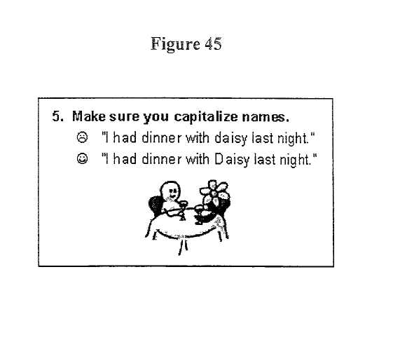

The present invention also provide tutorial daemons that are programs which run in the background and monitor the users' inputs. By monitoring a user's typing before the sentence is sent to the translation engine, the present invention helps to guide the user toward sentences that are more easily translated and warn them of dangerous inputs. When a problem is detected, it is marked in the text within the input box and a “warning light” comes up in an area of the screen dedicated to tutorial messages as illustrated in FIG. 47. The tutorial daemon can includes a spell checker, a grammar checker, a difficult phrase flagger and an input length meter.

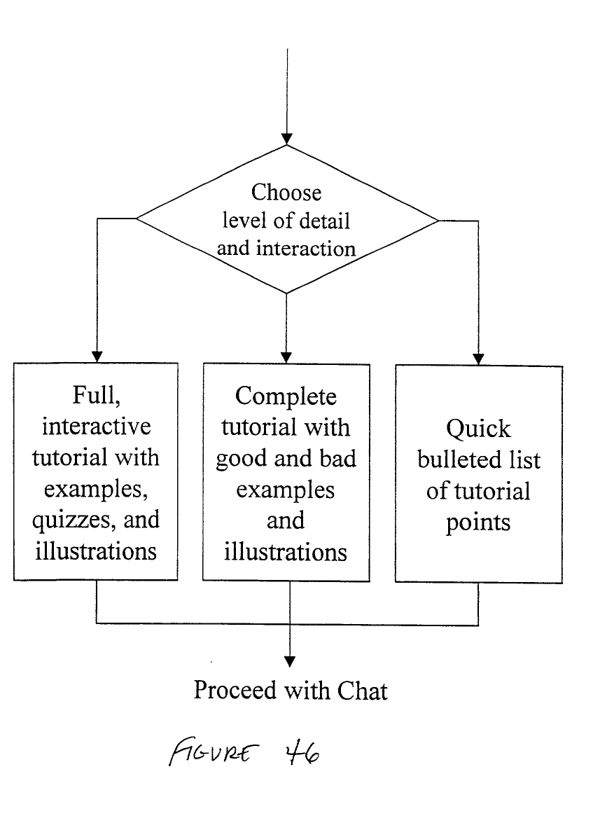

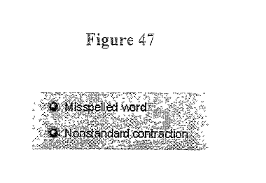

FIG. 48 shows how users' expectations and knowledge about the System are influenced through actual use of the System. For the chat application, as the user provides input the input goes through a tutorial daemon. The tutorial daemon is a second-level tutorial which runs in the background and gives feedback about the user's input. The tutorial daemon flags difficult words and phrases, troublesome constructions, spelling and punctuation errors, likely accent errors, troublesome zero-anaphora, unlikely part-of-speech sequences, and other possible sources of translation errors, in order to train the user. Further detail on the tutorial daemon is given in FIG. 49. In addition, the user receives feedback from seeing the translations that come through and other users give feedback in the form of the “Help?” button.

FIG. 49 illustrates the tutorial daemon, which provides a number of checking stages to provide feedback to the user. Before the user hits the enter button the tutorial daemon provides a warning of things to watch out for. The daemon includes (among other elements) a grammar checker, a spelling checker, a difficult-phrase detector, an input-length meter (to warn users about overly-long inputs), an ambiguity detector, and an ambiguity resolver, which uses local context to determine the meaning of ambiguous words and phrases.

The spell checkers reports each word that does not appear in one of the active lexicons. It does this by checking the current input line at short intervals before the return key is hit, and marking, either by highlighting, underlining, or some other graphical notation, that an unknown word has been found. This allows users to filter out spelling errors, non-standard words and slang, as well as problematic proper nouns before they are sent to the translation engine. When a user right clicks on a questionable word, a list of suggested alternatives is presented to speed correction.

The grammar checker checks grammer such as how punctuation is used. It also attaches part-of-speech tags to each word and checks to see if any unlikely tag sequences are detected. A questionable sentence or phrase is highlighted to notify the user that the user should rephrase the input if possible. Right clicking on the questionable phrase brings up an explanation of the problem and a possible suggestion for a fix. Examples of the grammer checker include checking to make sure every sentence in Japanese has a subject and verb, and if question words have the proper accent marks as in Spanish.

Aa number of languages have words and phrases that are not grammatically incorrect but are difficult to translate. Examples of such difficulties include “no” and “suki” in Japanese, the impersonal passive with “se” in Spanish; “got” in English, “marche” in French.. The difficult phrase flagger of the present invention highlights these to encourage the user to rephrase the sentence for better translation. A right click on the problematic expression brings up an explanation and a list of preferable rewordings.

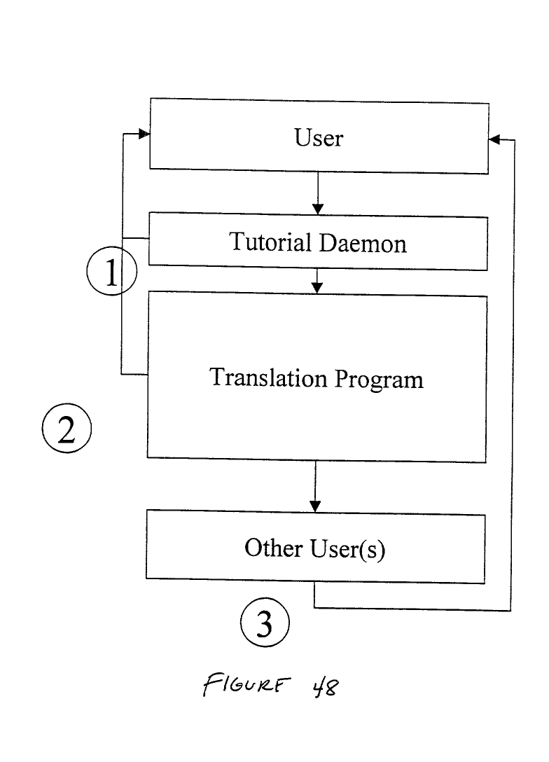

An input length meter is also provided with the present invention. Because translation quality declines with longer sentences it is important to keep input as short as possible. As a constant reminder of this, a small input-length meter is displayed next to the input text box in the chat application as illustrated in FIG. 50. The input box is periodically checked to see how many words, or in Asian languages, how many characters, have been entered, and increases the meter reading accordingly. Certain words, such as conjunctions, push the meter's needle up even further. After a certain word count, the meter enters a red “Danger Zone” which warns the user that their input is much more likely to be mistranslated. The Danger Zone level depends on the language and engine being used.

In contrast, in the context of Search Application of the present invention, inputs which are too short are the problem. In this setting, a daemon watches the queries a user inputs, and issues a suggestion if a number of one- or two-word queries are entered in succession. In cross-language search a major obstacle is the difficulty in translating the exact meaning of the search terms. The context of a number of search terms aids significantly in determining the exact meaning of the query words. The average number of words per query as reported in most studies is usually around two, so without encouragement most users will tend to enter these short queries and will probably become discouraged by the poor search results.

In both the chat and search applications the present invention checks the input for potentially ambiguous words and phrases. These ambiguous expressions are highlighted to encourage the user to rephrase the input for a clearer translation. Without this feedback, the user will often have no idea why a sentence or query produced such a bad translation. The ambiguous words can be detected by consulting a specialized word-translation dictionary which lists specific alternate translations for a word. Ambiguous phrases can be detected either by scanning for specific phrases (such as a “yes” or “no” following a negative question) or by executing a part-of-speech tagging and seeing if there are multiple tag sequences judged likely.

Once an ambiguity has been detected, an ambiguity resolution program can be triggered, either with a right click in chat, or automatically in search. The resolver can either consult surrounding context or other search terms to determine the most likely sense of the ambiguous word, or it can spawn a dialogue box to ask the user for clarification directly.

In order to track translation problems and provide feedback for refinements to the help files, lexicons, and tutorial daemons, the method and apparatus of the present invention logs every word which passes through the translation engine untranslated and also logs every input which receives Help button feedback from another user. These logs permit immediate recognition of any patterns in mistranslation which occur, including words missing from the lexicon, constructions not covered in the translation System's grammar, and frequent grammatical and spelling errors.

The present invention provides a number of aids and shortcuts to help users enter their input quickly and correctly. These include an iconic entry which provides a shortcut for input in the chat application. A user clicks on a series of special icons which immediately insert certain set phrases into his/her text entry box. These icons take three different forms serving different purposes.

FIG. 16 illustrates the wide variety of input aids incorporated into the System. These include typing short cuts (either by keyboard or mousing on a separate menu), emotions, a hyperlinked dictionary, buttons which introduce long phrases into the chat or other application, special characters which set apart text which is not to be translated, lists of words and phrases which are not to be translated, and automatic recognition of URLs in the text.

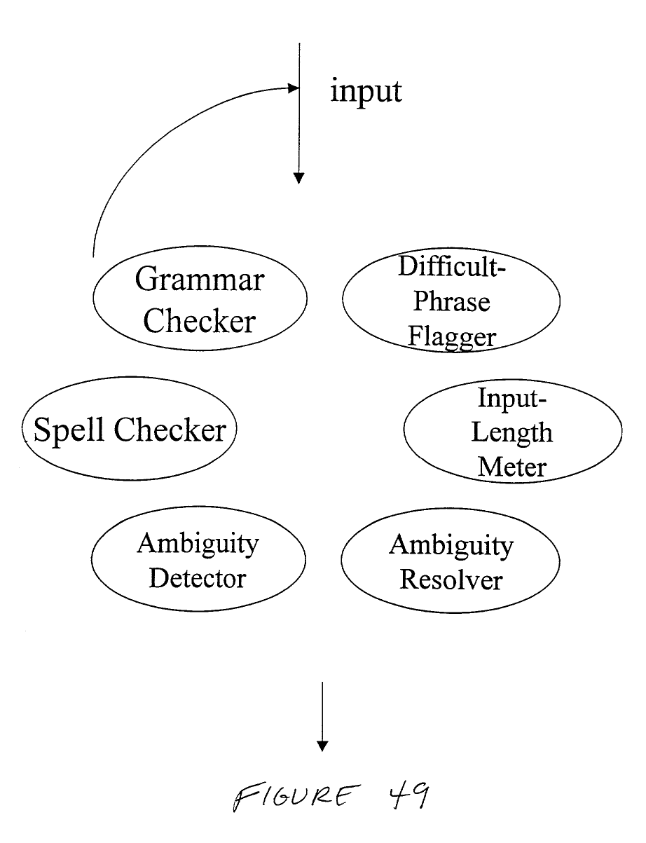

The present invention also provides typing shortcuts. The chat environment requires fast input and quick reaction to maintain a fun and interesting level of interaction. However, this pressure to increase input speed also encourages the user to cut corners which greatly harm the quality of translation. These cut-corners include abbreviating frequently repeated words, using pronouns, and leaving out subjects or verbs entirely, especially in Japanese. In order to facilitate fast input while discouraging these bad habits, the present invention shows the user a small window with a number of phrases which can immediately be entered into the text input line with a single click of the mouse as illustrated in FIG. 51. The phrases can also be accessed with keyboard shortcuts to make input even faster and simpler.

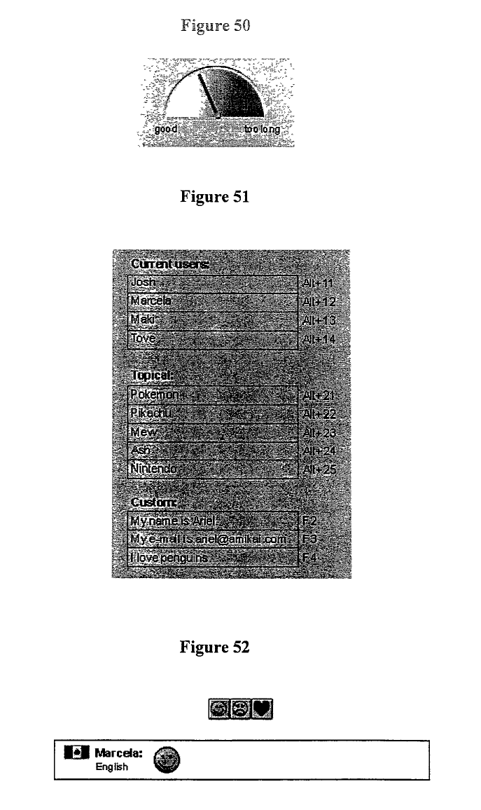

The present invention also provides a number of emoticons and illustrations that users can include in their messages, such as a smiley face and a heart that is illustrated in FIG. 52. These are transparent to the translation engine and thus will have no effect on the translation quality. However, they have a substantial effect on the user-friendliness of the System and the total ability of the users to communicate and connect with each other.

Action buttons are provided to enable a user to select from a menu of buttons which print out full sentences describing the user's attitude or actions. These range from the straightforward (“[User A] scratches his head.”) to the cute (“[User A] blows [User B] a kiss!”) to the silly (“[User A] dances the Macarena.”). Each action phrase is stored in each translated form, and is displayed to each user in the appropriate language.

Special characters are designated which signal the translation engine of the System of the present invention not to translate part of the input. The user simply surrounds the text not to be translated with these special characters and the translation The System of the present invention ignores that section of the input and sends it through verbatim. These are important when entering names which are also common nouns (e.g. Nick, Young, the Giants, Los Angeles), when entering titles which the user does not want translated, and when users are discussing actual language use and language learning and need to mention specific examples.

In addition to the special “do not translate” characters, users can construct a personal list of words and expressions which are not to be translated. With such a list, a user can record names and titles which he/she mentions frequently, removing the need to annotate them each time with the special characters.

With the present invention, hyperlink dictionaries are provided and permit a user to immediately bring up the dictionary definition for any word by right clicking on that word. This is important for users because many of them will be language learners or people interested in other cultures and they will want the ability to see immediately the meaning of new words they encounter. In addition, once a user has typed an input and seen it go out in its translated for to the chat room, the user might feel some concern that the intended meaning of the sentence was preserved in the translation. One way to reassure the user and give him/her the power to make sure the translation is correct is to make available the dictionary definitions of the translated words.

The dictionary definitions shown can either be the literal dictionary entries in their entirety, or a check of local context can be used to determine which particular sense of the word is correct for the sentence.

As a user enters a URL into the flow of chat, it is immediately recognized as such and is transformed into a hot link. This feature encourages users to trade links and information and will facilitate communication in the chat environment.

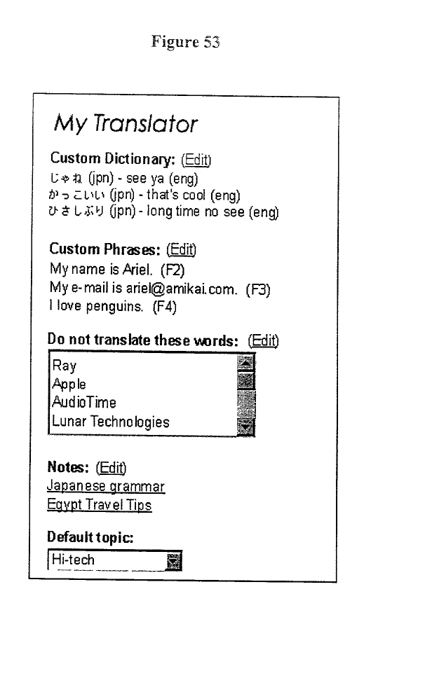

In order to help users produce the best translations possible for their particular interests, the present invention gathers a number of personalizing features into one area of the web site called “My Translator” and illustrated in FIG. 53. Users are encouraged to customize these features to their own particular needs. Not only does this produce better translations and greater user satisfaction it also encourages a sense of ownership in the translation technologies and will encourage repeated visits to the web site. The My Translator area includes the following:

1) User-Built Custom Dictionary: The user can collect and store words, phrases, and names which they frequently discuss, search for, or see web pages about.

2) User-Built “Do Not Translate” List: Names, titles, and phrases which the user usually does not want to be sent through the translation engine are collected in this list.

The present invention permits chatters to set their keyboard shortcuts to enter certain words and phrases automatically. Frequent chatters will appreciate being able to store these shortcuts from session to session.

If the user prefers to keep one of the subject-specific lexicons provided by the present invention as the default lexicon to use in web searches, web browsing, or chatting, this can be indicated in a “My Translator” area. Additionally, a general-purpose space is provided to the user to jot down notes while using the web browser, search engine, or chat rooms.

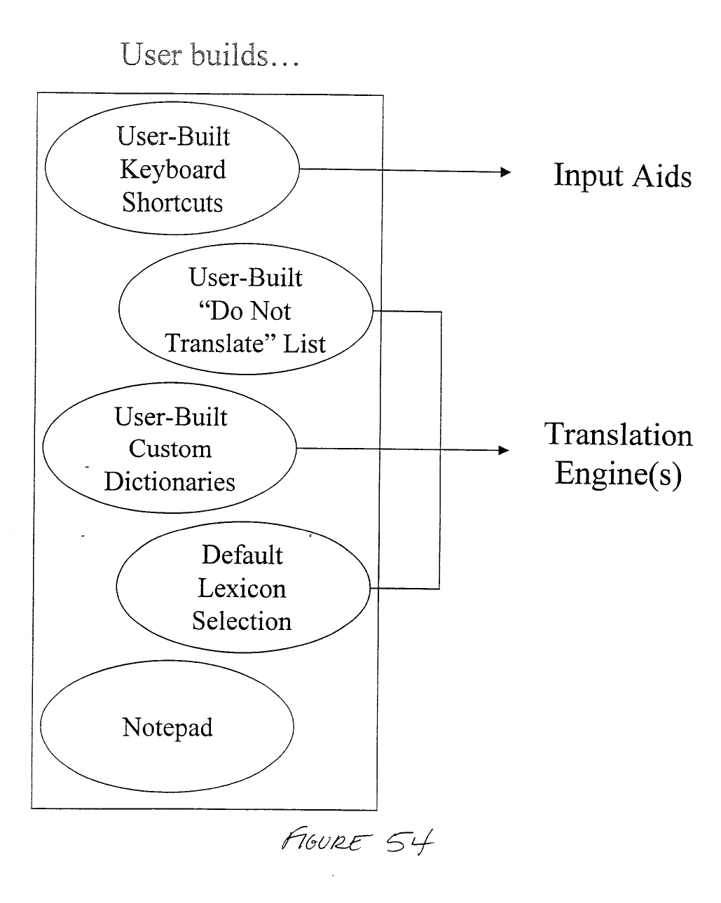

In FIG. 54, a number of personalization features are unified and presented in one section for the user's convenience. Each user is able to have their area where they keep their personalized dictionary, a personal “do not translate” list, personally chosen default lexicon selection, personally defined keyboard-shortcuts, and a notepad. This effects how all the other parts of the System, such as the browser, the auction translator, the translator for wireless, translated chat, and all other translation-based applications will work. It summarizes the information in one area, so a user can have control and can improve the quality of the translation engine performance for his or her own particular uses.

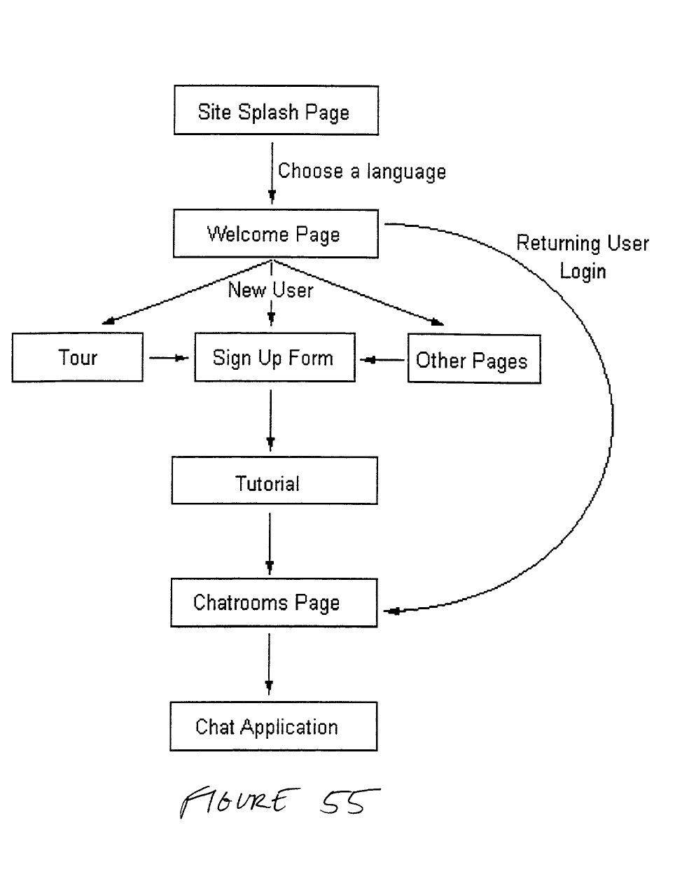

Referring now to FIG. 55, the user starts on the splash page, which just has the company logo, and a choice of languages. They choose a language, so that they can go into the website and have it be written in the language that they speak. From there on, the rest of the pages are translated into all of the languages that we offer. The next page that they see after the Splash page is the Welcome page and then from that page, if they are a returning user they can log right in, go to the chat rooms page, choose a chat room and start chatting. If they are new users, there are three main options. Ideally they would go to the sign up form, fill all of that out, then go to the tutorial, learn how to use the chat and then go to the chat rooms page. If they are not convinced that they should sign up on the Welcome page, then they can go to the tour, find out more about it, and then go to the sign up form. There are also a lot of other pages on the site that anybody can access. The web site of the present invention is built with different language zones. Initially a user comes in, selects a language. The user can change the viewing language of the site at any time.

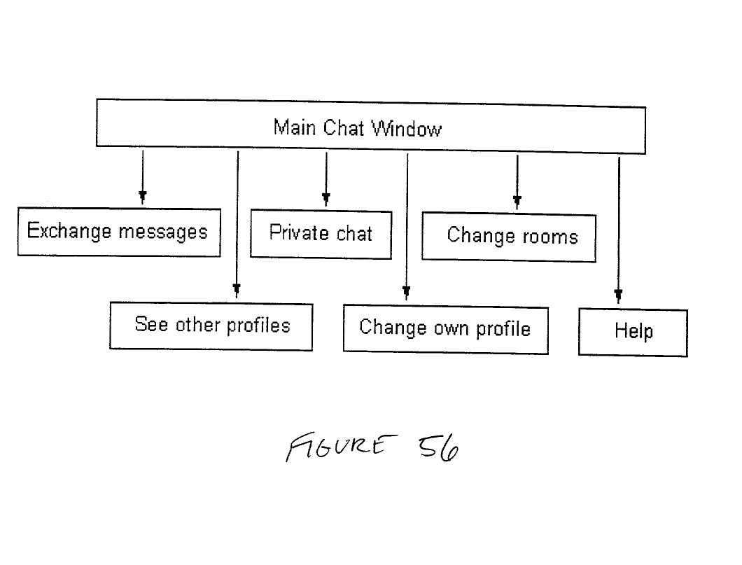

FIG. 56 illustrates that there are a plurality of different features in the chat application. The user can have conversations with other users by exchanging translated messages in the chatroom. The user can also open a private chat window in order to have a one-on-one conversation. The user can switch to another chatroom. The user can view profiles of other users and see their gender, location, age, occupation, fluent languages, country of origin, and personal message. They can edit their own personal profile, as well. And they can access the help section which includes a tutorial, translation tips, support form, and FAQ.

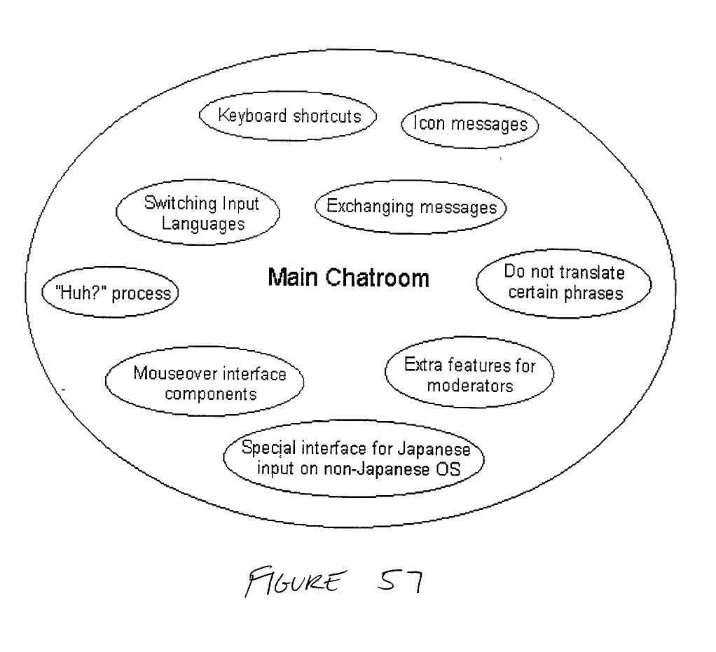

FIG. 57 illustrates that there are different features in the chat room. Examples include keyboard shortcuts for entering special characters, icon messages so users can send pictures (such as a smiley face) as a message. Bilingual users can switch the enter language control and enter in different languages. When the user moves the mouse over components of the chatroom, a description of that component appears in the mouseover tip box. Moderators have extra features, such as silencing other users or even eliminating their accounts if they are too disruptive.

There is also a special interface for people who want to enter in double-byte text but do not have double-byte operating system. For example, usually when a user enters text in Japanese, they enter the text phonetically and then hit return to select the characters they want to represent the phonetics. In Internet Explorer, if a user who does not have a Japanese operating system wants to enter text in Japanese, a small HTML window will appear and when the user hits return to select the characters they want to represent the phonetics, those characters will be automatically sent to the chatroom as well. In Netscape, there needs to be an extra HTML window in addition to a window where the user selects the characters. We will hide this extra window, so when the user selects the characters, it will look like it s being sent directly to the chat window instead of being sent to the intermediary HTML window and then to the chat window.

A “Do Not Translate” feature is also provided. This is utilized when the user is entering a phrase and wants to have a part of it not translated. For example, if they type in “Apple Computer,” in the English-French chatroom. They do not want “Apple” to be translated into “pomme,” the French word for “apple.” Right now we have a feature where they user can place “<>” characters around whatever they don't want to have translated. There are two ways to do this: they can use the Do Not Translate Button or type in the characters themselves. The Do Not Translate button is on the chat, and when they hit that button, the “<>” characters are always automatically inserted around the cursor. So when they type, they are actually typing between the “<>” characters already instead of having to go and put the special characters around it themselves. But once they learn that those characters keep the phrase from being translated, they can just type them in themselves instead of using the button.

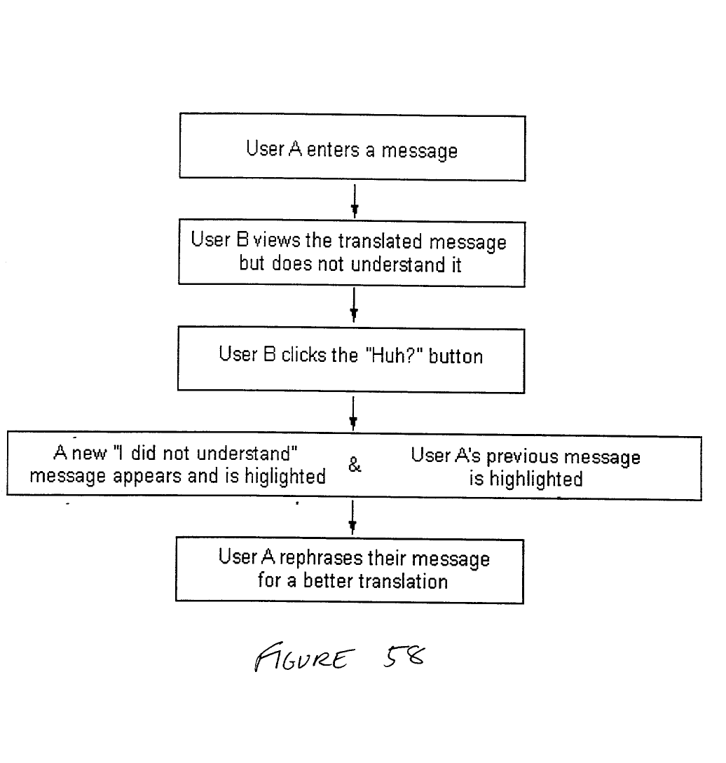

The Help process can be used when somebody enters a message that a user doesn't understand. The user can let the other party know that the user doesn't understand. We will go into more detail about this in FIG. 58.

The Help process is illustrated n FIG. 58. For example, user A enters a message with a typo. User B views the translation but doesn't understand it. User B can click the Help button that is on User A's message and right away it will put up a message that says, “User A, I didn't understand your message. Please rephrase it.” Both that message and the message that was misunderstood become highlighted. User A can re-enter the message so it can be translated again.

A keyboard shortcut is also provided: when the up arrow is pressed the previous messages appear in the text box where the user enters its message. Instead of retyping the entire message User A can hit the up arrow, fix the typo in the previous message, and send it again. This provides a fast way for people to be able to let each other know when there is any miscommunication. The highlighting makes the process clearer and faster as well. By highlighting the message it becomes much easier to spot the misunderstood message.

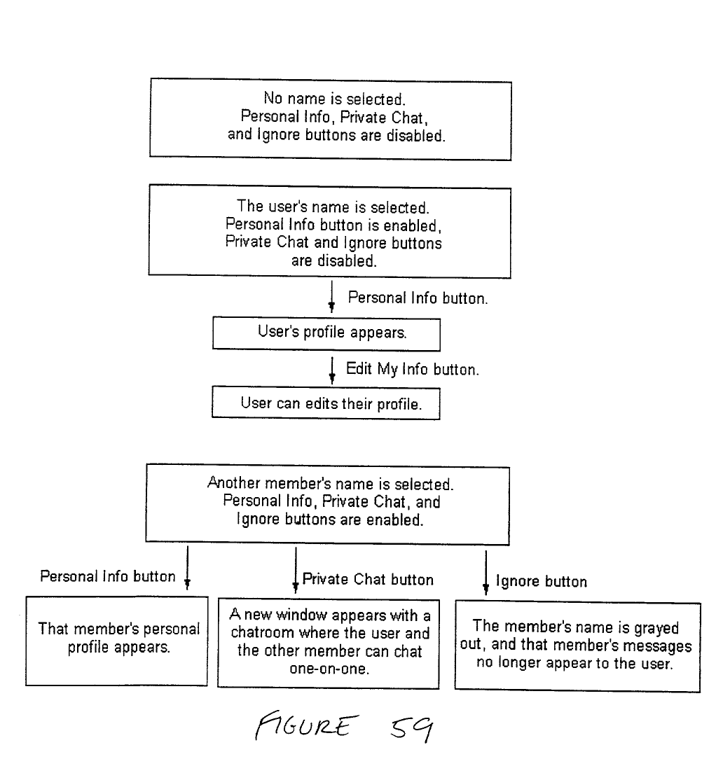

FIG. 59 illustrates the “current member's box”. In the upper right area of the chat room is a list of all of the members currently in the chat room. Different actions can be taken with the different members in the chat room. For example, a “personal information window” provides information on how to find a person. “Private chat” brings up a new window where a user chat one-on-one with that person and the “ignore button” is used to ignore a user and stop seeing their messages. If none of the names are selected all of these buttons are disabled. If a user's own name is selected then the user can see their own profile and edit it. The other buttons are disabled.

If a user's own name is selected the “personal information” button can be clicked so the user see its own information and the user can also edit its own information. Another button is provided on the “personal information” window which brings up another window where a user can edit its own profile information. If another member's name is selected, then all three of those features work. A user can see its profile, the user can chat one-on-one with that person in another window or the user can gray them out and stop seeing their messages.

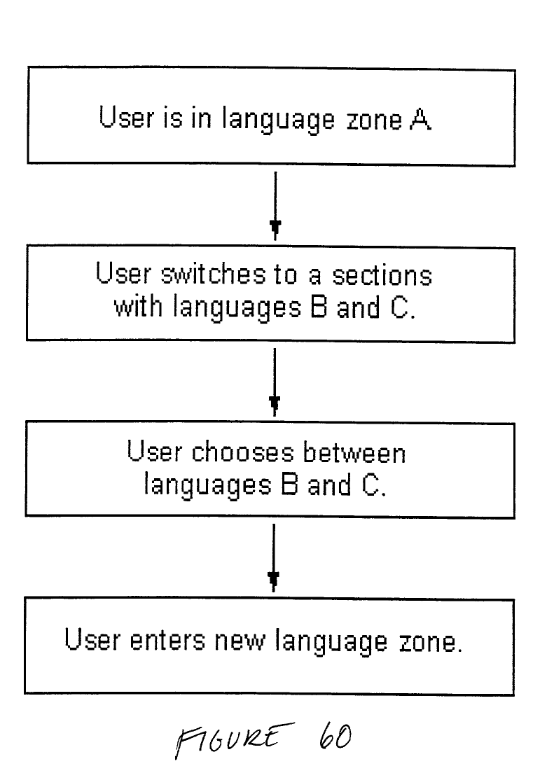

Switching language zones is illustrated in FIG. 60. For example, if a user is a viewing a website in French and decides to go to a chat room where another language is used, a window pops up that says “You are moving to a different language zone would you like to view it in English or Japanese?” The French user then selects the new language and from then on views the site or chat room in the new language.

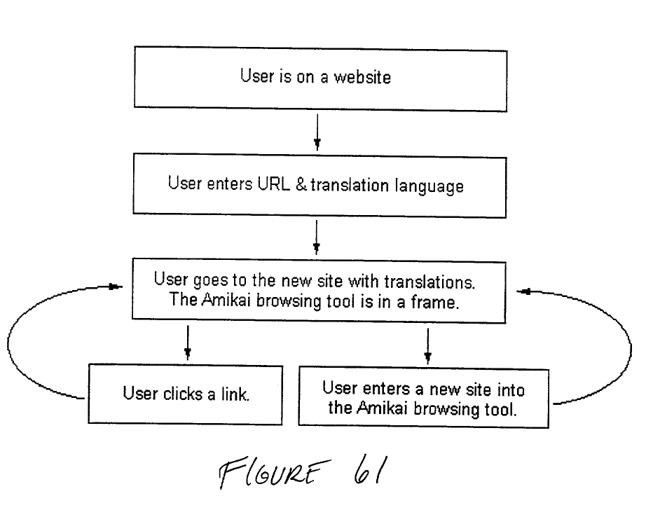

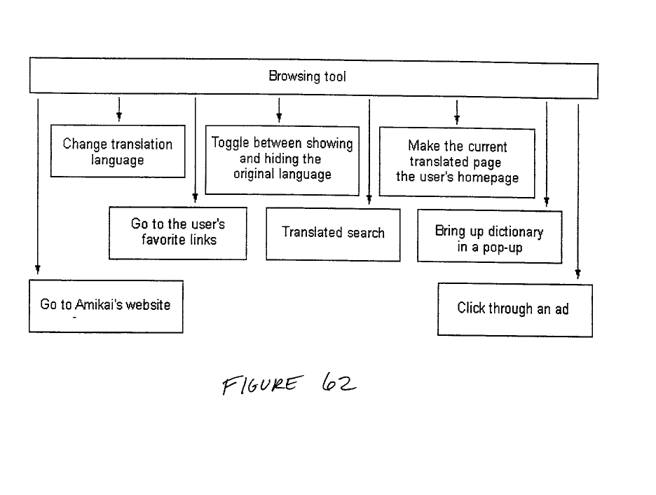

FIG. 61 is an overview of the browsing tool of the present invention. The browsing tool is a frame and has various features, more fully described in FIG. 62. The browsing tool is utilized when a user on one website enters the URL of a website he or she would like to translate. The user then goes to that new website with the translations. At the bottom of the window the user clicks on a link on the page and goes to that new page which is also translated. A user can also enter a new URL into the browsing tool and goes to that site translated.

FIG. 62 lists some of the browsing tool features. The browsing tool permits a user to change what language the site is being translating to, including “none”. Additionally, the user can customize it and have its own favorite links, set up its own look and feel, toggle between showing and hiding the original language. A multi-lingual dictionary pop-up is also provided.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A method for electronically translating text, comprising
providing an electronic language translator;
receiving source language text as an input of the electronic language translator;
translating the source language text at the electronic language translator into one or more target language texts;
and providing a first user with an option of viewing one or more of the target language texts with or without the source language texts.

2. The method of claim 1, wherein the electronic language translator includes at least a first translation engine.

3. The method of claim 1, wherein the electronic language translator includes a translation cache.

4. The method of claim 3, wherein the translation cache includes a store of phrase and equivalents across multiple languages.

5. The method of claim 3, wherein the translation cache includes a store of source and one or more target language equivalencies that are dynamically updated.

6. The method of claim 3, wherein the translation cache includes heuristics to enable matching between inputs and cache entries which are not typographically identical.

7. The method of claim 6, wherein the flexible matching heuristics include ignoring differences in the capitalization scheme.

8. The method of claim 6, wherein the flexible matching heuristics include ignoring differences in the punctuation.

9. The method of claim 6, wherein the flexible matching heuristics include dividing the input at punctuation such as commas in order to match phrases at a sub-sentential level.

10. The method of claim 6, wherein the flexible matching heuristics eliminate appellatives at the beginning and end of phrases before attempting the match.

11. The method of claim 6, wherein the flexible matching heuristics include a glossary of abbreviations, slang forms, and other non-standard forms in order to recognize all variants of the cached phrases.

12. The method of claim 6, wherein the flexible matching heuristics include ignoring diacritics.

13. The method of claim 6, wherein the flexible matching heuristics include unifying hiragana and katakana in Japanese inputs.

14. The method of claim 6, wherein the flexible matching heuristics include unifying small and large kana in Japanese inputs.

15. The method of claim 6, wherein the flexible matching heuristics include ignoring sentence-final expressive particles (gobi) in Japanese inputs.

16. The method of claim 1, wherein the electronic language translator includes a plurality of translation engines.

17. The method of claim 16, wherein the electronic language translator includes a multiple engine comparison tool that receives translated target language outputs from multiple engines and selects a desired output.

18. The method of claim 1, wherein the electronic language translator includes a pre-processor that improves the translatability of the source language.

19. The method of claim 18, wherein the pre-processor corrects the source language inputs for improved translatability by application of language-specific heuristics

20. The method of claim 18, wherein the pre-processor includes a spell-checker to correct spelling errors.

21. The method of claim 18, wherein the pre-processing expands acronyms and abbreviations that would otherwise not translate properly.

22. The method of claim 18, wherein the pre-processor includes an accent-restoration routine to correct deleted or incorrect accent marks.

23. The method of claim 18, wherein the pre-processor replaces slang with standard language equivalents which will translate better.

24. The method of claim 18, wherein the pre-processor replaces conversational constructions with language equivalents that translate better

25. The method of claim 18, wherein the pre-processor eliminates difficult to translate sentence-final expressive particles.

26. The method of claim 25, wherein the pre-processor eliminates gobi from Japanese inputs.

27. The method of claim 1, wherein the electronic language translator includes a tutorial to instruct users on use of the translator.

28. The method of claim 1, wherein the electronic language translator includes a composition tool that interactively guides the user to use translation-friendly language.

29. The method of claim 28, wherein the composition tool includes a spell checker that provides a notification to a user when the input includes a lexical item not found in dictionaries used by the system.

30. The method of claim 28, wherein the composition tool scans the input for at least one of specific words, phrases, and expressions which do not translate properly.

31. The method of claim 28, wherein the composition tool checks for lexically ambiguous words which cause translation problems.

32. The method of claim 28, wherein the composition tool monitors a length of the input and reminds the user that shorter inputs may translate better.

33. The method of claim 32 wherein the input length monitor uses heuristics to increase the input length count for terms that increase translation complexity.

34. The method of claim 33, wherein the heuristics increase the input length count for conjunctions.

35. The method of claim 28, wherein the composition tool scans the input for syntactic constructions which are difficult to translate.

36. The method of claim 28, wherein the composition tool scans the input for syntactic constructions which are ambiguous.

37. The method of claim 28, wherein the composition tool warns the user about accent errors and suggests corrections.

38. The method of claim 28, wherein the composition tool passes the input through a language model and warns the user when the model does not recognize the input with a desired certain confidence level.

39. The method of claim 38, wherein the language model is selected from a trigram model, bigram model, unigram model, or a linear combination of trigram, bigram, and unigram models.

40. The method of claim 38, wherein the language model is a Hidden Markov Model.

41. The method of claim 28, wherein the composition tool executes a preliminary translation of the input, passes the input through a language model, and warns the user when the model does not recognize the translated output with a desired certain confidence level.

42. The method of claim 41, wherein the language model is selected from a trigram model, bigram model, unigram model, or a linear combination of trigram, bigram, and unigram models.

43. The method of claim 41, wherein the language model is a Hidden Markov Model.

44. The method of claim 1, wherein the electronic language translator provides the user an indicator to indicate those portion of the input that are not to be translated.

45. The method of claim 44, wherein the indicator includes special characters placed before and after the text not to be translated.

46. The method of claim 44, wherein the electronic language translator replaces text not to be translated with a lexical term that is not changed by the machine translation engine.

47. The method of claim 46, wherein the lexical term is a randomly generated, very large integer.

48. The method of claim 46, wherein the lexical term is a randomly generated, very large integer concatenated with a sequentially generated integer to ensure that the same lexical term is not generated twice in one translation.

49. The method of claim 46, wherein the lexical term is a randomly generated alpha-numeric string.

50. The method of claim 46, wherein the lexical term is a randomly generated alpha-numeric string, concatenated with a sequentially generated character, to ensure that the same lexical term is not generated twice in one translation.

51. The method of claim 46, wherein the lexical term is a randomly generated alpha-numeric string, concatenated with a sequentially generated integer, to ensure that the same lexical term is not generated twice in one translation.

52. The method of claim 1, wherein the electronic language translator uses specialized dictionaries to maximize the quality of the translation.

53. The method of claim 52, wherein the specialized dictionaries are selected from topic-specific, application-specific and user-specific dictionaries.

54. The method of claim 1, wherein the electronic language translator retains information about the capitalization scheme of the input, and restores this scheme in the output.

55. The method of claim 1, wherein the electronic language translator retains information about the punctuation of the input, and restores this punctuation in the output.

56. The method of claim 1, wherein the electronic language translator provides a mechanism for viewers of the translate output to indicate to the inputting user when the translation has not been understood.

57. A method for electronically translating text, comprising
submitting source language text to an electronic language translator;
executing translation from the source language text at the electronic language translator to at least one target language at the time of submission of the source language text;
outputting the at least one target language text from the electronic language translator.

58. The method of claim 57, wherein the output includes at least one of the target language texts and includes at least a portion of the source language text

59. The method of claim 57, wherein a first user submits the source language text and a second user receives the at least one target language text.

60. The method of claim 59, wherein the second user creates a reply in response to the at least one or more target language texts and possibly the source language.

61. The method of claim 60, wherein the reply is sent to the first user.

62. The method of claim 61, wherein the reply is sent to the first user in the form of the original source language.

63. The method of claim 62, wherein the original and reply texts are disseminated to multiple users.

64. The method of claim 63, wherein the multiple users are each able to reply to the messages and the replies are also disseminated to multiple users.

65. The method of claim 64, wherein two or more users are communicating in a chat environment using an electronic language translator.

66. The method of claim 64, wherein two or more users are communicating in an instant messaging environment using an electronic language translator.

67. The method of claim 64, wherein two or more users are communicating in a discussion boards environment using an electronic language translator.

68. The method of claim 64, wherein two or more users are communicating in an email environment using an electronic language translator.

69. The method of claim 64, wherein two or more users are communicating in an electronic customer service environment using an electronic language translator.

70. The method of claim 69, wherein two or more users communicating in an electronic customer service environment are communicating in a chat customer service environment using an electronic language translator.

71. The method of claim 69, wherein two or more users communicating in an electronic customer service environment are communicating in an email customer service environment using an electronic language translator.

72. The method of claim 71, wherein the input text from the first user is analyzed for meaning.

73. The method of claim 72, wherein the analysis is triggered upon receipt of the input text without explicit instructions from a human operator.

74. The method of claim 72, wherein the input text from the first user is analyzed for meaning, and based upon the meaning the reply is selected.

75. The method of claim 75, wherein the analysis is triggered upon receipt of the input text without explicit instructions from a human operator.

76. The method of claim 75, wherein the reply text is delivered to the first user in the same source language as the original text.

77. The method of claim 57, wherein the at least one target language text is posted to an electronic marketplace system

78. The method of claim 77, wherein the at least one target language text is stored to a marketplace database.

79. The method of claim 77, wherein the at least one target language text is posted to the electronic marketplace system along with the source language text.

80. The method of claim 77, wherein the source language text is a description of an object in an electronic marketplace system and the one or more target language texts are a translation of the object description.

81. The method of claim 57, wherein the source language text represents a search query string, and the at least one translated text output is delivered as a search query string to an electronic search system

82. The method of claim 81, wherein the electronic search system returns one or more search results, which are then translated by the electronic language translator and returned to the original user in the original user's source language.

83. The method of claim 57, wherein the source language text is a request for a document, which is submitted from the original user's hardware using a software client, transported over a network, and delivered to a server.

84. The method of claim 83, wherein the requested document is a document augmented with information in the form of a markup language.

85. The method of claim 84, wherein the textual components of the document are extracted and translated into at least one target language by the electronic language translator.

86. The method of claim 85, wherein the textual components of the document are chosen from text, mouseovers, meta-tags, and cookies.

87. The method of claim 85, wherein hotlink within the document is rewritten as calls to the electronic language translator.

88. The method of claim 87, wherein hotlinks are rewritten as calls to the electronic language translator so that the linked documents are automatically submitted for translation.

89. The method of claim 87, wherein at least one target language output is returned to the original requesting user and reconstituted with non-textual portions of the original document according to the original markup language tags.

90. The method of claim 89, wherein the non-textual portions of the original document are chosen from graphics, pictures, formatting, backgrounds, frames, animations, sounds, and videos.

91. The method of claim 90, wherein the reconstituted document is returned to the original requesting user to preserve the original look and feel of the original requested document.

92. The method of claim 90, wherein the original user's hardware is a computer, the user's software client is a browser, the network is a network connection between computers, the server is another computer, and the markup language is HTML.

93. The method of claim 90, where the original user's hardware is a personal data assistant, the user's software client is a PDA browser, the network is a wireless internet, the server is a computer, and the markup language is WML or HDML.

94. The method of claim 90, where the original user's hardware is a phone, the user's software client is a WAP browser, the network is a WAP network, the server is a computer, and the markup language is WML or HDML.

95. The method of claim 90, where the original user's hardware is a phone, the user's software client is an iMode browser, the network is an iMode network, the server is a computer, and the markup language is WHTML.

96. A method for electronically translating text, comprising
providing an electronic language translator system that includes an electronic language translator and at least a first and a second dictionary, wherein the electronic language translator references the first dictionary and then the second dictionary in a process of translating source language text into one or more target language texts and the dictionaries are maintained in an application or customer hierarchy;
receiving source language text at an input of the electronic language
translating the source language text at the electronic language translator into one or more target language texts;
producing an output that includes the one or more target language texts.

97. The method of claim 96, wherein the electronic dictionaries include one or more of subject-specific, application-specific, customer-specific, and user-specific dictionaries.

98. The method of claim 97, wherein the specialized dictionaries are selected for use by the electronic language translator dynamically at the time of translation.

99. The method of claim 97, wherein specialized dictionaries are created by users of the electronic translation system.

100. The method of claim 97, wherein the specialized dictionaries are maintained in a hierarchical organization.

101. The method of claim 100, wherein the dictionary hierarchy can be augmented by users with user-created dictionaries.

102. The method of claim 97, wherein the specialized dictionaries are created, stored, and modified in a format that is independent of a specific translation engine.

103. The method of claim 102, wherein the specialized dictionaries are mapped into engine-specific formats by engine specific routines.

104. The method of claim 103, wherein the specialized dictionaries are engine-independent and usable by any translation engine.

105. A method for electronic language translation, comprising;
providing one or more translation modules receiving source language text from an input interface;
providing one or more input interfaces;
providing one or more output interfaces;
providing a generic data format which is independent of the translation modules, input interfaces, and output interfaces;
converting the input source language text from the format for a specific input interface to the generic format;
determining the one or more translation modules that provides an optimal translation;
routing the text to the module that provides the optimal translation;
converting text from the generic data format to a specific input format of a translation module;
converting the specific output format from a translation module to the generic data format; and
converting data from the generic data format into an output format suitable for an output interface.

106. The method of claim 105, wherein one or more translation modules is a translation engine.

107. The method of claim 106, wherein the one or more translation modules is coupled with a specialized dictionary with relevant vocabulary for a translation request.

108. The method of claim 107, wherein the specialized dictionary is chosen from subject-specific, application-specific, client-specific, and user-specific dictionaries.

109. The method of claim 105, wherein the one or more translation modules includes at least one static translation cache.

110. The method of claim 105, wherein the one or more translation modules include at least one dynamic translation cache.

111. The method of claim 105, wherein the one or more translation modules include at least one input pre-processing system.

112. The method of claim 105, wherein the one or more translation modules include at least one output post-processing system

113. A method for electronically translating text, comprising:
providing an electronic language translator coupled to an interface;
translating source language text at the electronic language translator into one or more target language texts;
outputting translated text in one or more target languages to an output interface;
providing controls at an interface coupled to the electronic language translator to dynamically select which of the one or more target languages are output at the interface;
varying the interface representation of text in the one or more target languages to allow a user to differentiate between the displayed languages; and
providing controls at an interface to create differentiation between one or more target languages.

114. The method of claim 113, wherein the electronic language translator outputs the source language input text, in addition to the one or more target language texts.

115. The method of claim 114, wherein the electronic language translator includes controls at the interface coupled to dynamically select which of the source and target languages are output at the interface.

116. The method of claim 115, wherein the electronic language translator varies the interface representation of the text in the source and one or more target languages to allow the user to differentiate between the display languages.

117. The method of claim 116, wherein the electronic language translator provides controls at an interface to create differentiation between the source and one or more target languages.

118. The method of claim 113, wherein the variation of the representation of the output is chosen from varying typefaces, varying colors, varying spatial placement, and adding typographic symbols.

121. A method for electronically translating text, comprising:
providing an electronic language translator coupled to an interface;
translating the source language text at the electronic language translator into one or more target language texts;
displaying the translated output to the original user; and
providing feedback to the original user about the quality of the translation.

122. The method of claim 121, wherein the translator with feedback displays the original input text aligned with one or more output target languages.

123. The method of claim 121, wherein the translator with feedback provides an electronic dictionary attached to the translated text.

124. The method of claim 123, wherein the attached electronic dictionary is used by the user to translate words from the translated text back into the source language, in order to double-check the translation quality.

125. The method of claim 124, wherein the attached electronic dictionary is hyperlinked to the words in the translated text.

126. The method of claim 125, wherein the hyperlinked dictionary is activated by clicking on a word.

127. The method of claim 126, wherein clicking on a word retrieves its translation from the hyperlinked dictionary.

128. The method of claim 126, wherein clicking on a word retrieves its definition from the hyperlinked dictionary.

129. The method of claim 124, wherein the attached electronic dictionary is activated by mousing over words in the translated text.

130. The method of claim 129, wherein mousing over a word in the translated text retrieves its translation from the attached electronic dictionary.

131. The method of claim 130, wherein mousing over a word in the translated text retrieves its definition from the attached electronic dictionary.

132. The method of claim 121, wherein the translator with feedback passes the translated text through a language model and indicates when the translated output is not recognized by the model with a minimum confidence level.

133. The method of claim 132, wherein the language model is chosen from a trigram model, a bigram model, a unigram model, or a linear combination of a trigram, bigram, and unigram model.

134. The method of claim 132, wherein the language model is a Hidden Markov Model.

135. The method of claim 121, wherein the translator with feedback indicates to the user words that were not translated by the electronic language translator.

136. The method of claim 135, wherein the untranslated words are indicated in the output text through visual means.

137. The method of claim 136, wherein the visual means are chosen from highlighting, differently colored font, italics, bolding, underlining, and surrounding the untranslated words with special characters.

138. The method of claim 135, wherein the untranslated words are returned to the user in a list.

139. The method of claim 121, wherein the translator with feedback is used simultaneously across a network by more than one user at different interfaces.

140. The method of claim 139, wherein the multi-user translator accepts input text from any of the multiple users.

141. The method of claim 140, wherein the multi-user translator displays to all of the multiple users the input text translated into one or more output languages.

142. The method of claim 141, wherein the multi-user translation system with feedback includes an indicator for users to indicate that a translation of an input was not understandable.

143. The method of claim 142, wherein the poor-translation indicator redisplays to all users the input which was not understandable in translation, along with a request to rephrase the input.

144. The method of claim 143, wherein the poor-translation indicator warning serves as feedback to the user that originally entered the input which was not understandable in translation.

145. A method for electronically translating text, comprising:
providing an electronic language translator coupled to an interface;
translating the source language text at the electronic language translator into one or more target language texts ;
producing at least two candidate translations for each source language text;
comparing the translated candidates to one or more language models trained on data similar in style and subject matter to the text being translated;
selecting the best quality translation for the input from the multiple translation candidates, according to which best matches the one or more language models; and
displaying a desired best quality translation.

146. The method of claim 145, wherein the multi-candidate electronic language translator includes two or more translation engines that each produce at least one candidate translation.

147. The method of claim 145, wherein the multi-candidate electronic language translator includes at least one translation engine which produces two or more candidate translations for each input.

148. The method of claim 145, wherein the one or more multi-candidate electronic language translator's language models are chosen from unigram models, bigram models, and trigram models, or a linear combination of unigram, bigram, and trigram models.

149. The method of claim 145, wherein the one or more multi-candidate electronic language translator's language models are Hidden Markov Models.

150. A system for electronically translating text, comprising
an electronic language translator that receives source language text input and produces translated target language text; and
and an interface coupled to the electronic language translator and configured to provide a user with an option of viewing one or more target language texts with or without source language text.

151. The system of claim 150, wherein the electronic language translator includes at least one translation engine.

152. The system of claim 150, wherein the electronic language translator includes a translation cache.

153. The system of claim 152, wherein the translation cache includes a store of phrases and equivalents across multiple languages.

154. The system of claim 152, wherein the translation cache includes a store of source and one or more target language equivalents that are dynamically updated.

155. The system of claim 152, wherein the translation cache includes a processing unit for executing matching between inputs and cache entries which are not typographically identical.

156. The system of claim 155, wherein the flexible matching unit includes a routine for ignoring differences in the capitalization scheme.

157. The system of claim 155, wherein the flexible matching unit includes a routine for ignoring differences in the punctuation.

158. The system of claim 155, wherein the flexible matching unit includes a routine for dividing the input at punctuation.

159. The system of claim 155, wherein the flexible matching unit includes a routine for eliminating appellatives at the beginning and end of phrases before attempting the match.

160. The system of claim 155, wherein the flexible matching unit includes a glossary of abbreviations, slang forms, and other non-standard forms, plus a routine for substituting standard forms for the glossary entries.

161. The system of claim 155, wherein the flexible matching unit includes a diacritic removal routine.

162. The system of claim 155, wherein the flexible matching unit includes a hiragana and katakana unification routine for Japanese inputs.

163. The system of claim 155, wherein the flexible matching unit includes a small and large kana unification routine for Japanese inputs.

164. The system of claim 155, wherein the flexible matching unit includes a sentence-final expressive particles (gobi) elimination routine for Japanese inputs.

165. The system of claim 150, wherein the electronic language translator includes a plurality of translation engines.

166. The system of claim 165, wherein the electronic language translator includes a multiple engine comparison tool that receives translated target language outputs from multiple engines and selects a desired output.

167. The system of claim 150, wherein the electronic language translator includes a pre-processor that improves the translatability of the source language.

168. The system of claim 167, wherein the pre-processor includes a language-specific source language input corrector for improved translatability

169. The system of claim 167, wherein the pre-processor includes a spell-checker unit.

170. The system of claim 167, wherein the pre-processor includes an acronyms and abbreviations expander.

171. The system of claim 167, wherein the pre-processor includes an accent-restoration unit.

172. The system of claim 167, wherein the pre-processor includes a slang replacement unit.

173. The system of claim 167, wherein the pre-processor includes a conversational constructions replacement routine.

174. The system of claim 167, wherein the pre-processor includes a sentence-final expressive particles elimination routine.

175. The system of claim 174, wherein the pre-processor includes a Japanese gobi elimination routine.

176. The system of claim 150, wherein the electronic language translator includes a translator training tutorial.

177. The system of claim 150, wherein the electronic language translator includes an input composition tool which interactively guides the user to use translation-friendly language.

178. The system of claim 177, wherein the composition tool includes a spell checker.

179. The system of claim 177, wherein the composition tool includes a difficult-to-translate phrase detection routine.

180. The system of claim 177, wherein the composition tool includes a lexically-ambiguous word detection routine.

181. The system of claim 177, wherein the composition tool includes an input-length monitor.

182. The system of claim 181, wherein the input length monitor includes a word demerit monitor.

183. The system of claim 182, wherein the word demerit monitor is a conjunction demerit monitor.

184. The system of claim 177, wherein the composition tool includes a difficult-to-translate syntax scanner.

185. The system of claim 177, wherein the composition tool includes an ambiguous construction scanner.

186. The system of claim 177, wherein the composition tool includes an accent corrector.

187. The system of claim 177, wherein the composition tool includes a language model.

188. The system of claim 187, wherein the language model is chosen from a trigram model, bigram model, unigram model, or a linear combination of trigram, bigram, and unigram models.

189. The system of claim 187, wherein the language model is a Hidden Markov Model.

190. The system of claim 177, wherein the composition tool includes a language model for preliminary translations.

191. The system of claim 190, wherein the language model is chosen from a trigram model, bigram model, unigram model, or a linear combination of trigram, bigram, and unigram models.

192. The system of claim 190, wherein the language model is a Hidden Markov Model.

193. The system of claim 150, wherein the electronic language translator includes a do-not-translator indicator.

194. The system of claim 193, wherein the do not-translate indicator is a set of special characters places before and after text not to translate.

195. The system of claim 193, wherein the do-not-translate indicator includes a translation-neutral token substitution routine.

196. The system of claim 195, wherein the translation-neutral token is a randomly-generated very large integer.

197. The system of claim 195, wherein the translation-neutral token is a randomly-generated very large integer concatenated with a sequentially generated integer.

198. The system of claim 195, wherein the translation-neutral token is a randomly-generated alpha-numeric string.

199. The system of claim 195, wherein the translation-neutral token is a randomly-generated alpha-numeric string concatenated with a sequentially generated character.

200. The system of claim 195, wherein the translation-neutral token is a randomly-generated alpha-numeric string concatenated with a sequentially generated integer.

201. The system of claim 150, wherein the electronic language translator includes specialized dictionaries.

202. The system of claim 201, wherein the specialized dictionaries are chosen from topic-specific, application-specific, and user-specific dictionaries.

203. The system of claim 150, wherein the electronic language translator includes a capitalization recording and restoration unit.

204. The system of claim 150, wherein the electronic language translator includes a punctuation recording and restoration unit.

205. The system of claim 150, wherein the electronic language translator includes a poor-translation feedback mechanism for the input user.

206. A system for electronically translating text, comprising
an input interface for submitting source language text to an electronic language translator;
an electronic language translator for translating the source language text to at least one target language at the time of submission of the source language text; and
an output interface for outputting the at least one target language text from the electronic language translator.

207. The system of claim 206, wherein the output interface produces as output at least one of the target language texts and at least a portion of the source language text.

208. The system of claim 206, wherein the input interface includes a text submission device and the output interface includes a translated text display device.

209. The system of claim 208, wherein the output interface includes a reply composition device.

210. The system of claim 209, wherein the output interface includes a reply submission device.

211. The system of claim 210, wherein electronic language translator includes a component to translate the submitted replies into the original source language.

212. The system of claim 211, wherein the electronic language translator includes components to disseminate the original and reply texts to multiple users.

213. The system of claim 212, wherein the electronic language translator includes interfaces which allow the multiple users to reply to messages and have the replies disseminated to multiple users.

214. The system of claim 212, wherein the electronic language translator is within a chat system environment.

215. The system of claim 212, wherein the electronic language translator is within a instant messaging system environment.

216. The system of claim 212, wherein the electronic language translator is within a discussion board system environment.

217. The system of claim 212, wherein the electronic language translator is within an email system environment.

218. The system of claim 212, wherein the electronic language translator is within an electronic customer service system environment.

219. The system of claim 218, wherein the electronic language translator is within a chat system environment in an electronic customer service system environment.

220. The system of claim 218, wherein the electronic language translator is within an email system environment in an electronic customer service system environment.

221. The system of claim 220, wherein the email electronic customer service system includes a first-user input text meaning analyzer.

222. The system of claim 221, wherein the first-user input text meaning analyzer is triggered by receipt of the input text without explicit instructions from a human operator.

223. The system of claim 221, wherein the email electronic customer service system includes an automatic reply-generation component which generates a reply based on the analyzed meaning of the input text.

224. The system of claim 223, wherein the reply generation component is triggered by receipt of the input text without explicit instructions from a human operator.

225. The system of claim 223, wherein the reply generation component generates the reply to the first user in the first user's original source language.

226. The system of claim 206, wherein the electronic language translator includes a posting tool to post at least one target language to an electronic marketplace system.

227. The system of claim 226, wherein the electronic language translator includes a storage routine to store at least one target language text to a marketplace database.

228. The system of claim 226, wherein the electronic language translator includes a posting tool to post at least one target language text to the electronic marketplace system along with the source language text. component

229. The system of claim 226, wherein the electronic language translator interprets the source language text as a description of an object in an electronic marketplace system and the one or more target language texts as translations of the object description.

230. The system of claim 206, wherein the electronic language translator interprets the source language text as a search query string, and includes an electronic search system configured to receive at least one translated text output as a search query string.

231. The system of claim 230, wherein the electronic search system's output interface translates the returned search results into the original user's source language using the electronic language translator.

232. The system of claim 206, wherein the electronic language translator's input interface accepts the source language text in the form of a request for a document, which is submitted from the original user's hardware using a software client, transported over a network, and delivered to a server.

233. The system of claim 232, wherein the electronic language translator includes a routine to interpret a markup language which augments the requested document.

234. The system of claim 233, wherein the electronic language translator includes a component to extract the textual components of the document and translate them into at least one target language.

235. The system of claim 233, wherein the textual components of the document are chosen from text, mouseovers, meta-tags, and cookies.

236. The system of claim 234, wherein the electronic language translator includes a component to rewrite the hotlinks within the document to be calls to the electronic language translator.

237. The system of claim 236, wherein the electronic language translator includes a component to reconstitute the at least one target language output with the non-textual portions of the original document according to the original markup language tags, and return the reconstituted document to the original requesting user.

238. The system of claim 237, wherein the non-textual portions of the original document are chosen from graphics, pictures, formatting, backgrounds, frames, animations, sounds, and videos.

239. The method of claim 237, wherein the reconstituted document is returned to the original requesting user to preserve the original look and feel of the original requested document.

240. The system of claim 237, wherein the original user's hardware is a computer, the user's software client is a browser, the network is a network connection between computers, the server is another computer, and the markup language is HTML.

241. The system of claim 237, where the original user's hardware is a personal data assistant, the user's software client is a PDA browser, the network is a wireless internet, the server is a computer, and the markup language is WML or HDML.

242. The system of claim 237, where the original user's hardware is a phone, the user's software client is a WAP browser, the network is a WAP network, the server is a computer, and the markup language is WML or HDML.

243. The system of claim 237, where the original user's hardware is a phone, the user's software client is an iMode browser, the network is an iMode network, the server is a computer, and the markup language is WHTML.

244. A system for electronically translating text, comprising:
an electronic language translator system that includes an electronic language translator and at least a first and a second dictionary, wherein the electronic language translator references the first dictionary and then the second dictionary in a process of translating source language text into one or more target language texts and the dictionaries are maintained in an application or customer hierarchy;
an interface for receiving input of the electronic language; and
an interface for outputting the source language text translated into one or more target languages.

245. The system of claim 244, wherein the electronic dictionaries include one or more of subject-specific, application-specific, customer-specific, and user-specific dictionaries.

246. The system of claim 245, wherein the electronic language translator includes a component for selecting which specialized dictionaries are to be used for translation dynamically, at the time of translation.

247. The system of claim 245, wherein the electronic language translator includes a specialized dictionary creation component.

248. The system of claim 245, wherein the electronic language translator includes a specialized dictionary hierarchy maintenance routine.

249. The system of claim 248, wherein the dictionary hierarchy includes a hierarchy augmentation tool to allow users to augment the hierarchy with user-created dictionaries.

250. The system of claim 245, wherein the electronic language translator includes creation, storage, and modification routines for the specialized dictionaries, a dictionary format which is independent of any specific translation engine, and a dictionary mapping routine which maps the independent dictionary format into engine-specific formats by engine-specific routines.

251. A system for electronic language translation, comprising;
one or more translation modules receiving source language text from an input interface;
one or more input interfaces;
one or more output interfaces;
a generic data format that is independent of the translation modules, input interfaces and output interfaces;
a conversion module configured to convert input source language text from a specific input interface to a generic format;
a routing module configured to determine the one or more translation modules that provide an optimal translation and then route the text to the module that provides the optimal translation;
a conversion module configured to convert text from the generic data format to a specific input format of a translation module;
a conversion module configured to convert specific output format from a translation module to the generic data format; and
a conversion module configured to convert data from the generic data format into an output format suitable for an output interface.

252. The system of claim 251, wherein one or more translation modules is a translation engine.

253. The system of claim 252, wherein the one or more translation modules is coupled with a specialized dictionary with relevant vocabulary for a translation request.

254. The system of claim 252, wherein the specialized dictionary is chosen from subject-specific, application-specific, client-specific, and user-specific dictionaries.

255. The system of claim 251, wherein the one or more translation modules includes at least one static translation cache.

256. The system of claim 251, wherein the one or more translation modules includes at least one dynamic translation cache is as a module.

257. The system of claim 251, wherein the one or more translation modules includes at least one input pre-processing system is as a module.

258. The system of claim 251, wherein the one or more translation modules includes at least one output post-processing system is as a module.

259. A system for electronically translating text, comprising;
an electronic language translator which translates the source language text into one or more target language texts;
an output interface that displays one or more target languages; and
an output interface configured to vary an interface representation of text in the one or more target languages.

260. The system of claim 259, further comprising:
controls at the output interface that permit a user to customize differentiation between source and target languages.

261. The system of claim 260, wherein the controls permit a user to customize differentiation between source and multiple target languages.

262. A system for electronically translating text, comprising:
an electronic language translator with feedback;
an interface for receiving input of the electronic language;
an interface for outputting the source language text translated into one or more target languages; and
a component for providing feedback to the original user about the quality of the translation.

263. The system of claim 263, wherein the translator with feedback includes a component for displaying the original input text aligned with one or more output target languages.

264. The system of claim 263, wherein the translator with feedback includes an electronic dictionary coupled to a main text.

265. The system of claim 264, wherein a hyperlink component couples the dictionary to the main text.

266. The system of claim 264, wherein a mouse-over component couples the dictionary to the main text.

268. The system of claim 263, wherein the translator with feedback includes a component to indicate to the user words that were not translated by the electronic language translator.

269. The system of claim 263, wherein the translator with feedback includes a component to display translated output to one or more other users.

270. The system of claim 269, wherein the translator with feedback includes a component for third party users to indicate if translation of the input was understandable.
